(19) United States
(12) Patent Application Publication
(10) Pub. No.: US 2010/0228630 A1
(43) Pub. Date: Sep. 9, 2010

(54) Advertising methods and system with improved media delivery platform

(76) Inventors: John Mikkelsen, Minneapolis, MN (US); Robert Freidson, St. Petersburg (RU); John P. Luther, Chicago, IL (US)

Correspondence Address: LADAS & PARRY LLP, 224 SOUTH MICHIGAN AVENUE, SUITE 1600, CHICAGO, IL, 60604, US

(21) Appl. No.: 12/592,532

(22) Filed: Nov. 25, 2009

Related U.S. Application Data
(63) Continuation-in-part of application No. 12/322,615, filed on Feb. 4, 2009.
Application No. 12/322,615 is a continuation-in-part of application No. 12/322,618, filed on Feb. 4, 2009.
Application No. 12/322,618 is a division of application No. 10/183,756, filed on Jun. 26, 2002, now Pat. No. 7,548,875.
(60) Provisional application No. 60/301,681, filed on Jun. 27, 2001.
(60) Provisional application No. 60/303,115, filed on Jul. 3, 2001.
(60) Provisional application No. 60/312,450, filed on Aug. 14, 2001.
(60) Provisional application No. 60/343,159, filed on Oct. 26, 2001.

(51) Int. Cl. G06Q 30/00; G06F 15/16; H04W 88/02

(52) U.S. Cl. 705/14.66; 709/247; 705/14.4; 455/567

(57) ABSTRACT

The present invention provides a method for delivering a multimedia data file, comprising advertising content and/or advertising visuals and/or copy from one or more servers to an electronic device or devices, comprising:
compressing said multimedia data file using a compression algorithm; and
transmitting the compressed file with or without an Internet connection, either wirelessly or by wireline, to an electronic device effective for receiving and playing back said multimedia file.

### CROSS-REFERENCES TO RELATED APPLICATIONS

This is a continuation-in-part application claiming priority to U.S. patent application Ser. No. 12/322,615, filed Feb. 4, 2009, and U.S. patent application Ser. No. 12/322,618, filed Feb. 4, 2009, which are continuation and divisional applications, respectively, of U.S. patent application Ser. No. 10/183,756, filed Jun. 6, 2002, now U.S. Pat. No. 7,548,875, which claims priority to U.S. Provisional Application Ser. No. 60/301,681, filed Jun. 27, 2001, U.S. Provisional Application Ser. No. 60/303,115, filed Jul. 3, 2001, U.S. Provisional Application Ser. No. 60/312,450, filed Aug. 14, 2001, and U.S. Provisional Application Ser. No. 60/343,159, filed Oct. 26, 2001, all of which applications are incorporated herein by reference.

### FIELD OF THE INVENTION

The present invention relates to novel advertising methods, including a new protocol and venue for conventional advertising usually deployed on TV, Internet, newspaper, magazine, billboard, radio-type advertising, lost-and-found advertising and essentially any type of venues, all of which may be performed remotely and wirelessly over-the-air without the need for an Internet connection, and which may be exhibited wirelessly on an electronic device, such as a portable electronic device in the form of a cell phone device, or a wire line device as desired.

### BACKGROUND OF THE INVENTION

As well known, the advertising industry is immense with spending reaching over a third of a trillion dollars a year. Many new and innovative methods of advertising and generating revenue are constantly being implemented, with some attempts finding more efficacy than others in selling and/or distributing various products and services. Many new advertising methods in general have also been in the subject matter for many new patent applications, of which just some of the very many examples include the following U.S. Application Nos.:
20060036493, 20060026067, 20060036495, 20060026059, 20060060098, 20060060743, 20060064350, 20060070381, 20050205310, 20050216346, 20050227679, 20050256768, 20050273811, 20050280257, 2006003117, 20060053049, 20060041474, 20060041471, 200660036494, 20050177416, 20050177430, 20050177461, 20050191164, 20050203794, 20050204385, 20050114526, 20050182676, 20050197888, 20040225560, 20040239703, 20040254857, 20050004836, 20050020368, 20050022117, 20050038900, 20050096982, 20050091111, 20050055274, 20050084329, 20050097204, 20050132267, 20050107158, 20050114183, 20050125286, 20050140133, 20050149397, 2005149403, 20050149432, and 20050160001

Each and any of the above-described advertising methods and products, and others whether yet known or still on the drawing board will be even more effective and useful when used in conjunction with the novel advertising and promotion methods and venues of the present invention employing the inventive new media delivery protocol which can be used via the Internet, or by bypassing the Internet entirely and enabling advertising to direct to one's portable electronic wireless device such as a cell phone. The present invention provides unique and heretofore unavailable business methods and opportunities of advertising and promotion methods and products.

### SUMMARY OF THE INVENTION

The present invention provides an entirely new and novel protocol for essentially any type of advertising, whether conventional or not yet known and which is especially suitable for use with cell phone visual displays and/or audio features, such as ring tones in the form of ring back advertising.

In a preferred embodiment, the present invention provides a method, system and products for wirelessly (or wire line) delivering a digital media file comprising of one or more advertisements in the form of audio and/or visual content from a central server or servers, or from one or more servers in any location, over-the-air to a wireless electronic device, or by a wireline, with or without an Internet connection, and wherein the digital media file is in an algorithmically compressed format.

The present inventive methods, system and products are more fully explained and understood with reference to the following detailed discussion of preferred embodiments with accompanying drawings.

### BRIEF DESCRIPTION OF DRAWINGS

FIG. 1 is a general schematic diagram illustrating the basic components of a wireless transmission system for a landline or cellular telephone.

FIG. 2 is a schematic diagram of a wireless transmission system for a cellular phone.

FIG. 3 is a schematic diagram of a board system implemented in an accessory unit of the system of FIG. 2.

FIG. 4 is a schematic diagram of a server software system for the system of FIG. 2.

FIG. 5 is a flow chart illustrating a data transmission method.

FIG. 6A-D illustrates the electrical schematics of a mobile telephone accessory unit in accordance with the present invention.

FIG. 7 illustrates an image of a printed circuit board for the accessory unit of FIGS. 6A-D.

FIG. 8 is an exploded side view illustrating the assembly of a cellular phone accessory unit and cellular phone attachment to the accessory unit.

FIG. 9 is a perspective view of the cellular phone accessory unit and cellular phone of FIG. 8, showing the cellular phone attached to the back of the phone connector and mounting of the accessory unit.

FIG. 10 is a perspective view of the accessory unit of FIG. 9, detached from the telephone.

FIG. 11 is a perspective view of the accessory unit of FIG. 9, disassembled from the mounting.

FIG. 12 is a schematic diagram of a landline transmission system for a home telephone.

FIG. 13 is a schematic diagram of a board system implemented in an accessory unit of a home telephone utilizing the system of FIG. 12.

FIG. 14 is a schematic diagram of server software for the system of FIG. 12.

FIG. 15 is a flow chart for an audio data parametric optimization and compression algorithm.

FIG. 16 is a schematic diagram of a protocol for a data transmission method with error correction delivery for a digital cellular telephone, illustrating individual packet acknowledgement for all packets for a half-duplex channel case.

FIG. 18 is a schematic diagram for a media file monitoring system.

FIG. 19 is a conceptual diagram of a delivery system, which includes an advanced cell phone system, and other devices, which can access a content server.

FIG. 20 is a schematic diagram of an advanced cellular phone system running client software in accordance with the present invention.

FIG. 21 is a schematic diagram of the software for the system of FIG. 20.

FIG. 22 is a front perspective view of an accessory unit, having a fish tail design, shown attached to a cellular phone, in accordance with an alternates embodiment.

FIG. 23 is a side view of the accessory unit and phone of FIG. 22.

### DETAILED DISCUSSION OF PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor or the present disclosure.

A great movement in designing new advertising methods and securing protection for these innovative methods and products is currently taking place, as shown in the Background of the Invention by the intensity of recent patent application filings. Some of the most effective of these innovative new methods employ Internet advertising and more specifically targeted advertising, such as, for example, theme-park photos, strategically inserted into a slide shop lineup and designed to enhance one's memories of a park. Targeted advertising provides more efficacious techniques available to advertisers to get their messages across.

Such targeted methods are thought to provide an edge in the world of advertising parity where many advertisers are attempting to employ similar methods, and which has the effect of diluting the impact of advertisements. Such dilution can result in a costly, but largely ineffective advertising campaign; therefore, better targeting prospects are always being researched to avoid such parity and ineffective dilution.

Just as television once paved the way for breakthrough advertising techniques some fifty years ago, the Internet has provided a new and highly effective advertising venue in recent years, with its advantages of measuring the impact of an advertisement company by counting the number of viewing visitors and to link any advertisements to search engine results. Internet advertising has generated in excess of $1.0 billion in 2009 alone. Newspaper advertising has seen a sharp decline almost certainly due to the advent of Internet advertising, and some observers expect to see total demise of conventional Newspaper advertising, and newspapers themselves, because of this decline. However, the effectiveness of Internet advertising itself waning, again due to parity and dilution.

To combat such parity, advertisements targeted to hit intended prospects, as opposed to the largely ineffective and expensive mass marketing techniques of old, and which can follow people via high-tech media right to their offices, taxicabs, private clubs, gyms, and autos are sought with potentially enormous payoffs, and with a concomitant minimizing of expense. Waste and effectiveness are traded for increased efficiency and reduced cost.

Some say the real advantage of Internet advertising is the ability to measure market effectiveness and home techniques to target specific prospects, and nail them with the products carrying advertisements that such a targeted audience really wants. These audiences tend to be subsets of groups, and especially Internet users, who care about specific articles and perhaps a way of life, or specific activities. These specific audiences' activities are then intercepted or approached and a product-sale-advertising relationship is thereafter established and which oftentimes demonstrates unusually efficacious sales activity. Some of those in business refer to such techniques as “persuasion engineering.” Another technique in which tracking of what an individual clicks on and looks at across a range of sites over a time period, and establishing a pattern or profile of such individual's interests, purchases and preferences, is referred to as “behavioral targeting.”

The present invention utilizes all of the aforementioned techniques in producing select targeting advertising with unexpected efficacy achieved in audience viewing and participation results in the form of sales.

Also contemplated herein is any type of personal advertising, such as might be found in newspapers and on Craigslist. Regarding personal advertisements, such are contemplated herein to be initiated and responsive in any city, state, region, territory or country in accordance with the present invention, and include essentially any type of subject matter typical of personal advertisements.

Some non-limiting examples include, for instance, advertisements under the general category of housing, with sub-categories for apartments and housing for rent or lease, or for roommates, subletting arrangements, housing or apartment wanted for lease or renting, roommates desired, housing or apartment swaps, vacation rentals, parking leases and rentals, storage space offered or wanted, and various types of real estate for sale, both commercial and residential.

Further contemplated are advertisements for employment or from those seeking employment, with any type of imaginable subcategories, including professional employment, part-time and temporary employment, such as in the fields of accounting/finance, architectural and engineering, general and sub-contracting, government employment, customer service, hotel, restaurant and club employment, sales and business development, real estate, manufacturing, medical and health-related employment, marketing and promotional employment, technical support and any kind of consulting, and the like.

Also contemplated are traditional personal advertisements for relationships, such as platonic relationships offered or sought, or others, such as one gender seeking another of the same or opposite gender for any type of reason or desire, or for people seeking more information on others, such as in missed encounters or of lost connections or in people location or identification endeavors.

Discussion or chat on blog forums are additionally contemplated, including without limitation, the coverage of such topics as auto, auto or vehicle reviews, pets, beauty, gifts, employment opportunities, the arts, religion, political topics, current events commentary, fitness, restaurant and bar reviews, wine, book reviews, electrical product and computer reviews, science, celebrities, and the like.

The sale, lease and/or bartering of any and all goods and services is also contemplated herein, inclusive of, without limitation, any kind of goods or products and services imaginable, for example, computer and electrical product servicing and troubleshooting, automotive and vehicle and/or watercraft related services, cleaning and restoration services, therapeutic services, travel and vacation services, event services, beauty services, erotic and adult services, legal, business, tax and financial services real estate and contracting services and the like.

The announcement of trade shows and conventions and offers for participation and the like is also contemplated, including auctions, concerts, vacation tours and other events, such as educational seminars.

In short, anything may be potential subject matter in accordance with this invention, and only limited by one's imagination, and of course, any particular local laws, rules and regulations, such as the advertisement of alcoholic beverages and tobacco products.

Mobile telephone advertising, with or without an Internet connection, such as with Short Message Service (“SMS”) text messages and Multimedia Messaging (“MMS”) providing text, animation and graphics are well known, and are recently finding extensive use in advertising. All of such methods are contemplated for use with the present invention.

Even more powerful advertising venues contemplated for use herein may be found in delivering direct to one's cell phone or land line, or computer desired, advertisement employing real music animation and the like, including inventive advertising methods, such as disclosed in U.S. Pat. No. 7,548,875, which is incorporated herein by reference.

The present inventive methods, systems and related product advantageously make use of a new protocol and venue for advertising in text, audio, video, animation and the like and with virtually any combination of audio and visual displays, and which is able to reach any audience anywhere at anytime, without the need for an Internet connection (or with one if so desired), and without the need for PCs or laptops. Any portable electronic device, such as a cell phone, may be employed which is effective to receive digitally compressed audio and visual content.

The inventive method and system further preferably comprises executing algorithmic means to compress the digital media file, storing the compressed file on a storage medium and executing by one or more server transmission means to transfer the compressed file from the storage medium by way of one or more wireless or wireline channels to the electronic device and wherein the electronic device comprises means for receiving and playing the compressed digital media.

Any mode of conventional advertising is contemplated for use herein, including such schemes analogues to television and radio advertising in which a cell phone user perhaps receiving free audio and/or visual digitally compressed content, such as real music and/or videos or movies, also receives advertising content periodically which is sold or leased, or provided for on any desired terms. In this manner there is provided a new venue for the sale of advertising time and space. In other instances, for example, when a phone “rings” the ring tone may be supplied free of charge, but be accompanied by some form of paid audio/and or visual advertising.

“Ringback” advertising is also contemplated for use with the new inventive protocol, wherein during the time span occurring when a phone is “ringing” and before it is “picked up” to receive a call, the caller or callee both are exposed to some form of advertising, such as prepaid advertising.

Commercial messages or political campaign, audio and/or visual displays are also contemplated, as well as lost-and-found messages, and the ever popular classified advertisements, such as employed on “Craigslist”, which may be housing sales, rentals, roommate advertisements, per advertisements, advertisements for services of any kind, personal classifieds of any kind, such as dating and the like, vehicle and watercraft advertisements and other classified advertisement limited only by one's imagination.

It will be appreciated, for example, that for example, with the use of a cell phone, essentially any type of advertisement or promotion of any kind is able to reach a far wider audience than a television or Internet audience many, many more times during the course of a day or other time period, and virtually anywhere there exists any type of wireless (or wireline) telephone service.

The opportunities for new business endeavors employing the inventive advertising protocol is essentially limitless, and is seen to dwarf the television, radio and Internet advertising market, not to mention any other kind of advertising venue, in coming years, eventually heralding a new advertising revolution.

Exemplary embodiments provided herein to be employed with or in conjunction with advertising methods may provide an improved media for delivery and play back of sound and image files which include songs, musical compositions, and other sound recordings cartoons, movies, television shows, or any other type of performance, which may be copyright registered, as well as non-copyright registered personal recordings (e.g., personal sound recordings, family photos, home movies, etc). This new method may include the use of sound and/or image clips, which can be snippets or full files, as alerts for a variety of electronic devices or for playing on a handheld device. A collection or library of uniquely selected and/or edited clips may also be provided to the consumer in a manner far more conventional telephone equipment than previously available.

The method may provide the consumer with a unique way of accessing and browsing through selectable files, which may be Internet based or independent of the Internet. Additionally, the unique delivery method may provide a seller or service provider with a convenient and more efficient way of promoting and selling entire sound and image files which include downloadable music, movies, films, shows, and items such as records, cassette tapes, CDs, videos, and DVDs.

Algorithms are provided for the delivery, storage and playback of the sound files, including a delivery method algorithm, a parametric optimization and compression algorithm, and an error correction algorithm.

A recent advertisement operating system for use with, inter alia, a personal computer (PC), personal digital assistant (PDA), cell phones, media players, vehicle entertainment systems, and other wireless and e-mail devices is disclosed in U.S. Application Publication No. 2009/0265214. This system is said to include an advertising component that is configured to disable at least one function of an operating system to present advertisements, such as by presenting them on a display device, and then enabling the displayed function or functions in response to the advertisement ending. The present invention is a major improvement on the advertisement operating system disclosed in U.S. 2009/0265214, the entirety of which is incorporated by reference herein, by permitting and enabling the transmission of multimedia advertisement files, including audio and/or image files or combinations thereof, to electronic devices, either wirelessly or by wireline, and with or without an Internet connection, and without the need to disable any function, such that a viewer or listener of the advertisement(s) may also, for example, when employing a cell phone, simultaneously engage in conversation or some other activity while the advertisement is being displayed, or may interactively engage certain functions prompted by or suggested or offered by the advertisement while the advertisement is being displayed.

According to one exemplary embodiment, sound files are accessed by a cellular or landline telephone, or personal data assistant (PDA) or Blackberry-type device for allowing the consumer to browse, download, hear and/or purchase sound files, or use sound files including sound clips as ringer sounds. In contrast to the conventional ring tones or musical chimes used to ring cellular phones currently on the market, the current invention provides a method for ringing cellular phones (both analogue and digital) and landline telephones with real sound recordings including real music, which may be songs lifted from copyright registered CD tracks, and may comprise human voice, various instrument sounds, and other sound effects of a high quality. Instead of simply tones being played the higher fidelity musical composition can be played by the telephone or other handset with a degree of fidelity previously unavailable using conventional methods. The high degree of fidelity is achieved using data compression, error correction and parametric optimization algorithms adaptable to conventional telephones and other handheld devices.

A software based system for encoding the hardware of existing cellular phones at the time of manufacturing with delivery, storage, and playback capabilities in accordance with the present invention is provided, such that additional hardware is not required. (Only a suitable speaker need be required with most telephones already in possession of the necessary quality of speaker.) The ability to provide this technology without the need for extra hardware is very significant, particularly to the cellular phone industry, as it is especially desirable to make cellular phones as lightweight and as small as possible and at the lowest cost.

An accessory attachment to standard cellular or land-lined telephones, PDAs, etc. may however be incorporated to implement the delivery, storage, and playback capabilities of the present invention to existing landline and cellular telephones which have not been encoded at the time of their manufacture, if necessary. Such accessory attachments may be compatible with existing telephones, and/or devices and may be sold separately. Also, a microchip may be embedded in landline telephones, or a separate device may be provided, for providing the telephone with browsing, delivery, storage, and playback capabilities of exemplary embodiments.

The accessory attachment or telephone encoded with software and/or including hardware for providing delivery, storage, and playback capabilities as described herein, may be manufactured with embedded sound files including sound clips, such that a user can immediately play back the files, including use the files as ringer sounds, without having to first download any files.

Additionally, upon hearing a sound clip on the television, for instance, a user may choose to download the entire unedited sound file for a fee or purchase an item associated with the sound clip (e.g., record, cassette tape, CD, video, DVD) by pressing a designated button on the accessory attachment or keys on the telephone keypad. As such, sound clips which have been downloaded to, or preprogrammed on a cell phone, may encourage and stimulate the sale of downloadable files and/or items associated with the clips by allowing the user to make an impulsive purchase immediately upon hearing the clips.

The accessing of sound and/or image files by other electronic devices, such as home phones, computers, pagers, doorbells, alarms, palm pilots, watches, clocks, PDAs etc., for either allowing the consumer to browse, download, hear, view, and/or purchase sound recordings, image files, or associated items, or to use sound and/or image clips as alerts is also a part of the invention and not limited to solely telephones. New electronic devices, whose independent purpose is to allow the user to browse, receive, store and play sound and image files, including clips, according to the present invention are also described.

A security feature may be included on such electronic devices adapted for allowing a consumer to access and use sound and image files according to the present invention. This feature is designed to prevent intellectual property abuse by consumers' unauthorized dissemination and reproduction of copyright protected material. The downloadable chips or recordings are coded and cannot be downloadable or transfer-red to units other than the consumers' pre-selected layer or telephone.

Also, a tracking feature for keeping a record of every song downloaded and/or each time a song is played can be incorporated for providing performing rights organizations or songwriters' organizations with an accurate method for determining royalty payments to writers and performers of music.

Additionally, a website suitable for viewing and selecting downloading sound and/or image clips or entire files may be used for giving the consumer and music or image seller a unique way of transacting the sale of such files or other associated items such as records, cassette tapes, CD's, videos, or DVD's. The website may allow the clips to be stored on a user's computer, providing the user the ability to readily access the clips for downloading the clips to an electronic device, using the clips as computer alerts, or playing the clips on the computer. The user may also purchase files or items associated with the clips through the computer and/or website.

The system of the present invention may also allow the consumer to browse through hundreds or thousands of sound and/or image clips and/or files for the purpose of downloading to electronic devices with an option to purchase an associated record, cassette tape, CD, video or DVD, or download the full unclipped sound and/or image file.

Furthermore, the delivery of files including clips is not limited to web based applications. Unlike conventional methods which require computer plug-in devices for delivering and transferring digital music, the current invention may use a delivery method which allows the user to browse, download, and listen to or watch sound or image files without the need for hand wired plug-in device or a computer connection to the internet.

Use of Sound and/or Image Clips as Alerts for Electronic Devices

According to one embodiment the system allows for sound and/or image clips, which are snippets of a musical and/or visual performance piece to be used for sound and/or image alerts in electronic devices. A library or collection of uniquely edited clips may be provided to the consumer for browsing and selecting files to be stored on the electronic device. The consumer may also use home made personal clips (e.g. personal sound recordings, family photos, home movies, etc.).

The sound and/or image clips may be lifted from CD's, movies, TV shows, and the like, and are actual recordings, which may include human voice, instrument sound, and other sound effects, rather than mere electronic chimes or tones as those produced by conventional cellular phones.

Electronic devices which may utilize sound and/or image clips as alerts include, but are not limited to cellular phones, land line phones, computers, clocks, watches, pagers, door bells, car alarms, palm pilots, and personal calendars. It should be understood that although using clips fro alerts is preferable, full, unedited files might also be used.

According to one embodiment, real music sound clips are used to “ring” a cellular or home phone. A clip or series of clips, which the user can select, are played instead of the conventional electronic chime or ring tone. Such a system can be implemented on conventional cellular phones, which may be analogue or digital, by downloading firmware, comprising algorithms for delivery, storage, and playback of the sound files to the RAM element of the phone. Such algorithms include a delivery method algorithm, a parametric optimization and compression algorithm, and an error correction algorithm. Alternatively, an accessory unit that can be attached to the cellular phone for implementing the system of the present invention may be provided.

According to another embodiment, sound and/or image clips are used for computer alerts such as email notification sounds. Clips may also be used to ring a doorbell. A clock or watch to sound at the beginning of each hour, similar to a grandfather clock, wherein a different sound clip may be played at each hour, may further use sound clips.

The present invention allows the user to store hundreds of different alert clips on a device. Unlike conventional electronic equipment which bold a limited number of selectable alerts, such as a conventional car alarm or music player alarm clock, the present invention allows the user to choose from an unlimited number of clip files including allowing the user to Create his own alert clips, or to choose from a library of uniquely selected and/or edited files, including samples taken from CD's, movies television shows and the like.

A cellular phone, or similar device (having a processor, RAM, and flash elements) may be integrated with software at the time of manufacturing for implementing the system of the present invention. Alternatively, a chip may be embedded into the device or an accessory unit, including a speaker, which attached to the device for implementing the system of the present invention, may be provided. The accessory unit may have an adapter connection to the device. Such accessory unit may be sold with several adapter outlets to enable it to fit onto a variety of different electronic devices.

Sound and/or image clips may be pre-stored on the electronic device or accessory unit at the time of manufacturing, such that the computer may be able to use the chips for alerts, without first having to select and download clips.

A user of an electronic device, according to the present invention, may download and store a number of clips off of a website via a plug-in connection of the device to the computer, or via a wireless network system such as Applet Airport. Additionally, a non-internet based holding system, which may be especially adapted for delivering clips to the electronic device or accessory unit may also be provided. Such holding system may be accessed via a phone dial in connection wherein a user may interact with the holding system by using the phone keypads or voice commands. Other controls for interacting with the holding system, such as control buttons, voice commands or text keypads, may be provided on the accessory unit or the electronic device itself which may be especially adapted for interacting with such holding system. The accessory unit or electronic device itself may also be sold preprogrammed with embedded clips for demonstration use.

Additionally, such electronic devices may be capable of receiving or sending clips directly from one device to another device. To prevent transferring entire files from one device to another, a security feature may be included on the devices and work in conjunction with the file.

One method of preventing transferring of files is to encode each electronic device or accessory unit with unique scrambling/unscrambling wave capabilities. As such, when a user transfers an entire file to his device, say a cellular phone, for which he pays a fee, a scrambling wave, which may be a function of his unique telephone number, may be encrypted in the file.

Upon playing the file, the user's cellular phone sends the corresponding unscrambling opposite wave. Other devices purchased by the same use may also include the unique scrambling/unscrambling wave encryption capabilities associate with the user's telephone number. As such, the files may only be played with the clarity on the device or devices owned by the user, even is such files are transferred to other devices.

Another method of preventing the transferring and reproduction of files is to use subscriber identity information of a telephony SIN card as an authorization key that would enable the user to authorized. Based on this method, the user's authorization key may be transmitted to the holding unit when the user requests the server to download a selected music clip file, wherein the key is encrypted in the file. After the file has been downloaded from the holding unit to the cell phone, the encrypted key may be compared with the actual subscriber identity information, for allowing use of the file only if the identity is successfully matched.

The security lock mechanism allows the original music or its representative to control distribution of music, and also provides an opportunity for music distributors to keep track of who plays their music. As such, a method of accounting for royalty payments to artists and performers and other parties registered with performing rights organizations such as ASCAP and BMI may include providing a tracking feature on electronic devices used by businesses such as bars, restaurants, and clubs to play music. In addition to allowing a record to be kept as to which music files have been downloaded and stored on the electronic device, the tracking feature may also record information on how many times and when each song has been played. This allows performing rights or music writers organizations the ability to keep an accurate record on which to base royalty payment distributions.

An electronic device having stored sound or image clips may include various features, which allow the user to preprogram the clips to play in a set sequence or a random order. (For example, certain clips, which may be from the same or different songs, may play in a congruous or back-to-back order with a fixed silence time between the clips.). Additionally, the device may have features allowing the user to classify and arrange the clips based on categories such as the type of clip (i.e., movie, song, etc), artist name, time period, etc.

Thus, a user of an electronic device utilizing the clips according to the present invention will be able to arrange the clips through a website from which the clips can be downloaded onto the device, or through the device itself.

Additionally, after listening to or viewing the clip, the user can choose to download the entire file from where the clip originated (i.e., the entire movie, song, etc.). The server providing the clips and the files may provide the clips for free or for a small fee as inducement for the consumer to ultimately download the entire file for which a greater fee may be charged.

An electronic according to the present invention may also have the ability to receive clips, which are directly transmitted onto the electronic device via audio or visual broadcasts. The user of an electronic device may program the device to sound a specified broadcast as an alert sound. For example, sound segments from a live radio show (i.e., a sports show or a commercial) may be used to ring a cellular phone by either the caller or the callee.

Advertisements may also be transmitted through the electronic devices according to the present invention. A message such as “pick up the phone and don't forget to drink Coca Cola™” may be used to alert of an incoming call. Such transmitted advertising messages need not necessarily function as alerts.

Additionally, this invention contemplates the use of image and sound clips, which can be combined such that the user can create a unique clip of both sound and image for use in electronic devices having display screens. For example, a phone having an appropriate display Screen can be preprogrammed to display a visual clip of a caller accompanied by sound, or a computer alert may display an image clip with sound. An image clip may comprise a single image frame or a picture clip as well as an animation.

### Website to be Used as a Support Tool for Downloading Clips to Electronic Devices and Method for Selling

According to a preferred embodiment, a website for downloading sound and/or image clips holds a library of clips, each clip having a specific identifying code or icon which may include, for example, the title of a musical composition or movie from where the clip originated, the name of the artist, a code number, or other type of identification depending on the type of clip. For example, a song clip may be listed as barrywhite@lovestuff.wav or may display the picture of the song artist or CD cover of the CD on which the song appears, along with the name of the song. The list may be' organized according to the artist's name, by music classification (i.e., pop, jazz, R&B, hip hop, etc.), by length of the sound clip, by the type of sound clip (i.e., song, piano music, guitar music, loud, quiet, etc.), or any combination of these categories or other conventional categories depending on the type of clip (image or sound). The website may also include categories of longer clips which may be more suitable for phone rings, and shorter clips which may be more suitable for computer alerts. The website may further contain a suggested list of weekly or daily favorite clip picks, which may be provided for each category or subcategory. Additionally, items or subcategories in a given category may be organized alphabetically, by year of copyright, or any other conventional order.

Tables 1 and 2 are examples of possible arrangements for sound clips using music classification and artist name. Note that listings of Table 1 such as barrywhite@lovestuff.wav are not websites, but use symbols associated with web use, such symbols being one of the many arbitrary ways of listing the clips. The symbol-driven listings may end with other non-domain suffixes such as “pop”, “song” etc. Additionally, this invention contemplates the user of the website hyperlinks associated with each listing as shown below in Tables 1 and 2.

| R&B | Jazz | Rock |
|---|---|---|
| Barry White | Herb Alpert | Chicago |
| Barrywhite@lovestuff | herbalpert@sunspots.pop | Chicago@feelings.- |
| | | wav |
| Barrywhite@deepvox | Herbalpertgdatinggame.pop | Chicago@times.wav |

TABLE 1

| R&B | Jazz | Rock |
|---|---|---|
| Barry White | Herb Alpert | Chicago |
| BW-01 A-Sexy | HA-01 A-Date | C-01 A-Begin |
| BW-01 A-Love | HA-01 A-Bull | C-01 A-Search |
| BW-01 A-Peace | HA-01 A-101 | C-01 A-Color |

The clips also have an identifying number associated with each clip. Such identifying numbers may be used in downloading the clips to an electronic device using a telephone (described 15 below) or other device having a number keypad. The website may further include a virtual personal locker or storage area for storing a selection of clips personal to user which can be accessed on the website by a unique user identification name or code. As such, a user can store clips for later purchasing, downloading to the user's cellular phone, playing, etc. The website may also allow the user to upload personal clips such as family photos, voice recordings, home movies, and the like, to the storage locker for later downloading to the user's cellular phone or other equipment. The storage locker may include an organizer for storing the clips in alphabetical order, by various categories, or any other words.

The website may allow for direct downloads of the clips from the website to the computer itself or to other electronic devices.

To illustrate how downloading through the website may be carried out, a user operating the computer may drag his/her mouse over the various listed sound or image clips and click on one or more selected clips. Thereafter, a box can appear prompting the user to select the appropriate electronic device onto which the clip or clips are to be downloaded (e.g., the box may say “CELLULAR PHONE DOWNLOAD OR COMPUTER ALERT DOWNLOAD?”) Assuming that the “CELLULAR PHONE DOWNLOAD” button is selected, a prompt for typing in appropriate cellular phone number will follow. Thereafter, the selected clip or clips may be uploaded to the user's personal locker and made available for downloading to the user's personal locker and made available for downloading to the user's handset.

Other features may also be included, such as an option allowing the user to arrange multiple downloads in a specific order, create a folder for grouping multiple downloads, or a feature incorporated into the phone which causes it to ring a selected clip immediately after it has been downloaded. Additionally, clips, which have been previously downloaded may be deleted, rearranged, or reclassified with or without using the website. (There are other methods for storing clips on an electronic device such as a cellular phone, some of which are described below, including direct downloading access for phones without the need for web phone access capabilities.)

Alternatively, by clicking “COMPUTER ALERT DOWNLOAD,” the selected clip will be downloaded to the user's computer, allowing the user to select many different sound and image clips for computer alerts, such as email notification, computer alarm clock, and computer calendar notification.

Additionally, multiple clips may be associated with one type of alert, such that a different clip is played for each alert event. The user will be able to rotate alert clips and preprogram or randomize their order similar to a CD stereo carousel.

The user will also be able to hear or view a selected clip which will play on the website upon the user's command. Browsing capabilities wherein the user can drag his mouse over the sound clips library of selections and hear the clips without having to click or open a file that may be included in the website. According to a preferred embodiment, a user simply drags his mouse over various clip samples, which light up or flash and play one at a time. Any time the user places the cursor over a category of music, the first tune in that category plays, and the icon representing that category of music switches to display the name of the artist and title of the song or composition being played. Once the user clicks upon that icon, he can select the next song and hear that song while at the same time seeing the name of the artist and song title. The user can cycle through all the songs within that category using this approach very quickly to not only browse but to also hear the music. If the user does not wish to switch over to another category of music, he ‘simply moves the cursor to another icon and repeats this procedure. To select a particular song the user double clicks on the song, which is then included in a collection of selected songs to be downloaded later.

The website may be used as a shopping forum where consumers can hear or view the clips and click to buy items associated with the clips such as music records, cassette tapes and CD's, DVD's, and movie videos, or download the entire sound or image file to their computer for a fee. By allowing the user to sample and download clips for use as alerts in electronic devices, the website will provide an attraction forum for selling items associated with the sound and image clips, and for allowing the user to download the entire file associated with the,clip, for which a fee may be charged.

Additionally, an identifying mini icon such as the song title or recording artist CD icon associated with a clip of with a group of clips may appear on the computer screen at a fixed location and/or at the screen display where the clip plays a computer alert. The icon may include a “buy” button, which will allow the user to purchase an item associated with the clip, or download the entire file from which the clip originated by clicking on the button. Such “buy” buttons may be a hyperlink to a website for transacting the purchase. Where a CD icon is not used, the user may click on the song title to purchase an item associated with the clip. If the clip comes from a song that exists on more than one CD, the customer will see more than one CD cover to choose which CD to buy.

The utility of clips as alerts for electronic equipment will provide consumers with incentive to browse the website and sample clips. After hearing or viewing the clip, consumers may be induced to purchase items associated with the clips, which they will be able to do instantaneously through the website by the click of their mouse.

The website may further be used a contest forum. The website may be set up to play mystery clips or short segments of sound recordings which contestants will have to identify in order to win a prize (i.e., by being the first to email or call with the correct answer). Thus, a radio show may set up a game where a short segment of a sound clip is played on the radio user's phone for contestants to guess and is also available for the listeners who want to hear it again on the website.

The website may include forwarding capabilities, such that a sound or image clip can be forwarded as a greeting to a friend. (The security feature may be used only to prevent transferring of entire files). Consequently, the website will attract customers for the purpose of downloading clips to electronic devices and ultimately purchasing items associated with the clips. Additionally, the user may subscribe to a service such as an existing cell phone service provider for downloading files through their telephone, without having to be online.

The user may also create a clip (e.g., by recording a song or personal clip) and store the clip onto a sound storage element in the electronic device. Additionally, the electronic device can be preprogrammed with the clips selected by the manufacturer retailer of the device.

Accessing of Sound and/or Image Files Without Access to the Internet

Sound and/or image files which include clips may be downloaded without use of the Internet by allowing the user to access a library of clips via their cellular phone or home telephone or providing other electronic devices with features which allow automatic access to the library. (Although Internet free accessing will be described with respect to a telephone, it is to be understood that the method described may be compatible with any electronic device preferably having accessing capabilities similar to a telephone).

The library may be a non-web holding unit that has files with associated codes which match the codes associated with the files on the website, wherein the website serves as a usable guide for identifying various files according to associated codes, such as numerical codes to assist the user in downloading files using voice commands or keypad commands.

Additionally, cellular phone or home telephone users may access a non-web holding unit with library of stored files which can similarly be browsed, selected, and downloaded onto the phone using user voice commands, or by connection to a live operator. Such unit may be accessed by dialing a phone number (e.g., an 800 number). Home telephones and cellular phones may have separate holding units, such as a satellite for cellular phones and a ground unit for home phones, or cellular phones to access a ground-holding unit can use a satellite.

To facilitate selection of the files from such holding unit, the access system may provide for a code associated with each file which may be obtained by browsing the website as described as above. As such, a user connected to the holding unit would access the code associated with the file to select and download the file to the user's telephone.

Many other methods allowing a user to select files from the holding unit are possible. For example, the telephone may include a voice recognition feature, wherein the user can say the name or part of the name of the song he wishes to select (e.g., “Strawberry Fields” or the name of the song artist). The phone may also utilize hierarchical submenus whereby the user may press dial keys with letters corresponding to a selection in a given category, which ultimately leads to the selection of a particular song. A phone having a screen display for providing a text listing of the names of songs or categories, according to hierarchical submenus, may also be used for enabling the user to narrow down to a list of songs and/or artists from which he can make his final selection.

A telephone may likewise be used to deliver files stored on the phone to a website, and email address, another telephone, or other electronic device. Sound clips, which are segments of whole songs, musical compositions or other sound recordings, will be used mostly with telephones, however, downloading entire music or image files may also be done, subject to the security feature described above. Additional revenues may be generated as the consumer accesses the content library and uses airtime while browsing and downloading clips or entire songs from the library-holding unit.

Furthermore, cellular phone and home telephone service providers may offer extra features to phone subscribers which would allow the subscribers to download and store sound files for user with the telephone in accordance with the present invention. Such features by service providers may include a personal sound file storage box (which may be a file of clips and/or entire sound files) that the user can access via a personal code. The user may be charged a monthly file fee for a subscription to the service, and/or per downloading of each song, whether or not the user is a subscriber. The service provider can generate additional revenue even if the service is provided without a special charge since consumers will use more airtime.

### Telephone Using Sound Clips

A telephone having stored sound clips that may comprise real music including human voice, various instrument sounds, and other sound effects may allow the user to select one sound clip or a rotation of several clips to “ring” the phone. Although it is preferable to ring the telephone with sound clips, an entire music file may also be used, whereby for example, a song may start playing and continue until the user picks up the telephone. (Of course, entire music files may be played on the telephone solely for the user's listening pleasure). The telephone may also be programmed to ring a conventional chime if the user so chooses. Such a telephone may utilize a storage chip carrying stored sound clips as well as the conventional phone chime programmed onto it.

Additionally, the telephone may allow the user to determine how many times a clip is to repeatedly play for each ring, and the time delay between clips in a given ring. The user may also choose to mix different clips in one ring. A telephone may also include a looping feature which rings the telephone in a looped clip such that the clip plays repeatedly without a pause between repetitions of the clip, or a “cluster” feature which rings a “cluster clip” comprising a multiple number of clip segments from a single song, musical composition, or other sound recording playing in sequence.

Other features will allow the telephone user to preprogram the telephone to play a certain clip when a specific individual calls, thereby allowing the user to identify the caller based on the chosen sound clip. Each person who regularly calls the user may have a unique identifying ring. This will allow a telephone user to have the option of assigning a unique sound caller ill to each of an unlimited number of callers. Other features may include allowing the caller to select his own personal sound clip to “ring” the telephone of the recipient of the call. (For example, the caller may sing or record “Happy Birthday” song.) Also, a telephone used by more than one user may utilize sound clips for a callee ill function wherein the caller identifies the intended callee (e.g., by dialing a digit or sequence of digits) and the telephone plays the clip associate with the callee.

Additionally, a telephone may be provided with a “caller message recorder feature” which allows the caller to record his/her own message to send to the number dialed. For example, the caller may send a message such as “Hey John. It's Mary. Pick up the phone,” by pressing a “record ring” button on his/her phone to send such a message to John's phone. As described earlier, the telephone user, say John, may have a caller ID feature such that when a certain caller, Mary calls, the telephone rings with a predetermined message or sound clip selected by John. The additional caller message recorder feature may cause John's telephone to play Mary's message instead of overlaying the predetermined caller ID message or clip. Additionally, John may record his own message such as “It's Mary” and associate that recorded message with Mary's phone number for a caller ID ring.

A telephone, according to the present invention, may also include a “sensory feature” for enabling the telephone to sense the level of ambient noise and adjust the loudness of the “ring” accordingly. If the phone “senses” very loud background noise, for example, a cellular phone located in a loud restaurant, the ring volume will increase. A feature for detecting whether a cellular phone is located in a pocket book or a place where the “ring” sound may be muffled is also contemplated. This feature will also enable the phone to adjust the volume of the “ring” such that the “ring” will be loud enough for the user to hear. Such detection mechanism can be achieved by detecting ambient light and other conditions.

Additionally, the user may manually adjust the volume of the ring via a tunable volume control mechanism or a multiple fixed settings control. (Although the above features are described with respect to a phone, it is to be understood that these features may also be provided with other electronic devices utilizing sound and/or image clips as alerts where applicable).

### Transmission System for Delivery Clips to a Telephone

FIG. 1 is a schematic diagram illustrating the basic components for a wireless transmission system 100 for a telephone 102, having a wireless or landline service provider.

The system is described in terms of two main components: a storage clip chip 104, and a server 106. The storage chip 104 is an element associated with the telephone, which may be embedded into the phone or into an accessory unit which attaches to the phone, having abilities to interface with the phone. The existing hardware of a cellular phone may also be integrated with a software system, which may be downloaded to the RAM element of the cell phone for incorporating the present invention, without the need for extra hardware. As such, the existing hardware of the cellular phone may be made to perform the same function of the chip.

The purpose of the chip 104, is to store a selection of clips, allow for downloading of clips to be stored on the chip 104, and allow for the playback of clips, either by the telephone of the chip 104. (Although the description herein refers to sound clips, it is to be noted that entire sound files may be stored, downloaded, and played, according to the system described). Additionally, the chip 104 can associate the stored clips with a caller ID so that that particular clip to be played back is determined by the caller subscriber ID.

The server 106, which is associated with a collection of stored clip files 108, is designed to execute requests of the chip 104, which may be given through user voice commands or commands using the phone keys. The server may be equipped with a voice adapter 110 for supporting the ITU-TV.253 standard and telephone lines attached to the voice adapter. The voice adapter can also support some standard modem protocols, like V.32 or V.34, if required compatibility.

The server 106 also allows for file to be transmitted to the chip 104 for storage. The system 100 enables a connection to the server 106 upon a request from the chip 104, utilizing the phone, and/or PSTN (Public Switched Telephone Network), and/or a voice card (voice modem) attached to the server computer.

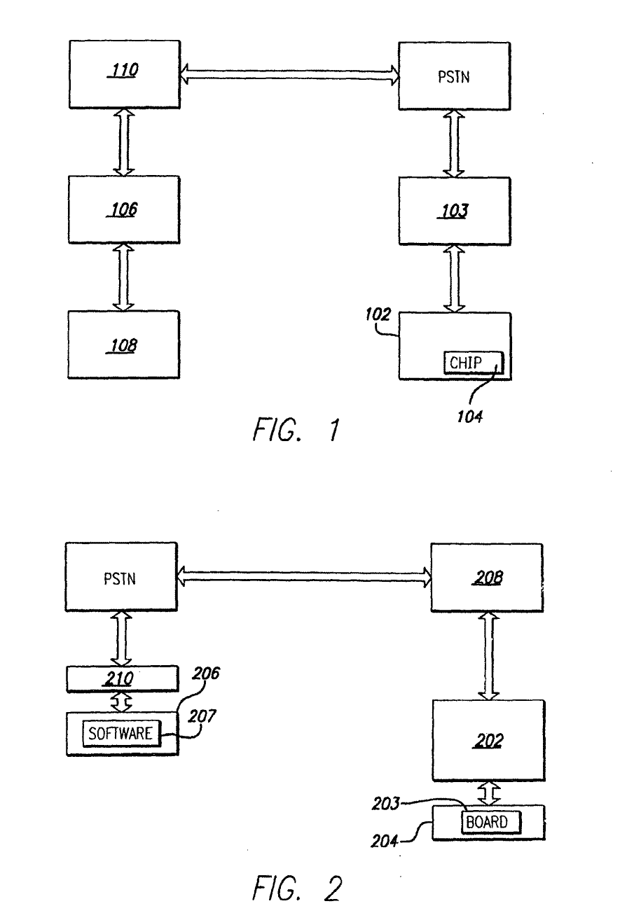

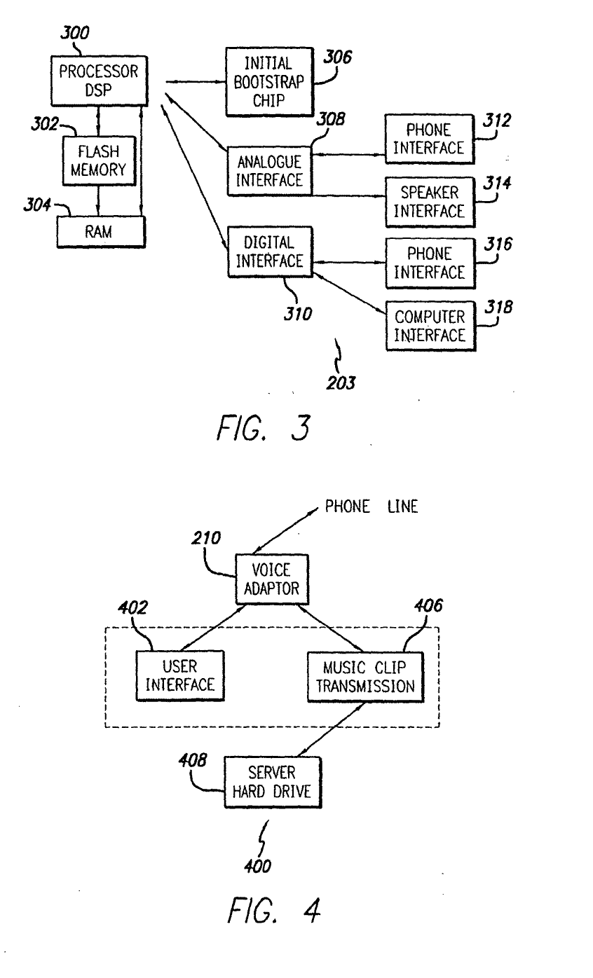

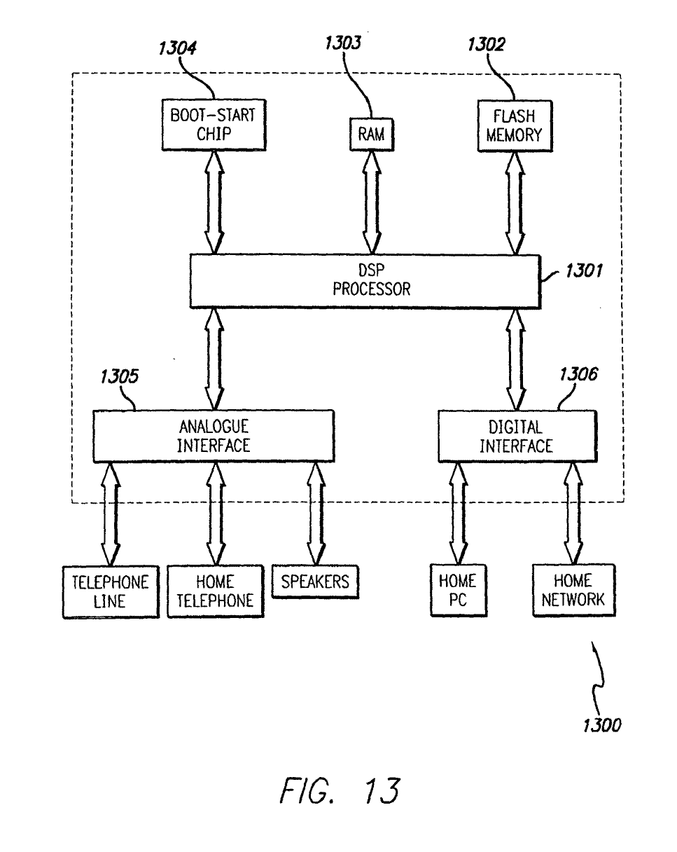

The system may have a voice menu, which, after connection to the server 106, allows the user to listen to the server's menu and navigate through the system of voice menus using the telephone's Dual Tone Multi Frequency (DTMF) keys. The system may allow the user to select and download clips by allowing the user to listen to the clips presented by the server 106, select a clip, and issue a download command to the server 106. The server then sends the selected clip (e.g. in digital compressed form) using a Custom Data Transmission Protocol (CDTP) over the voice channel. (Illustrated in FIGS. 2 and 12).

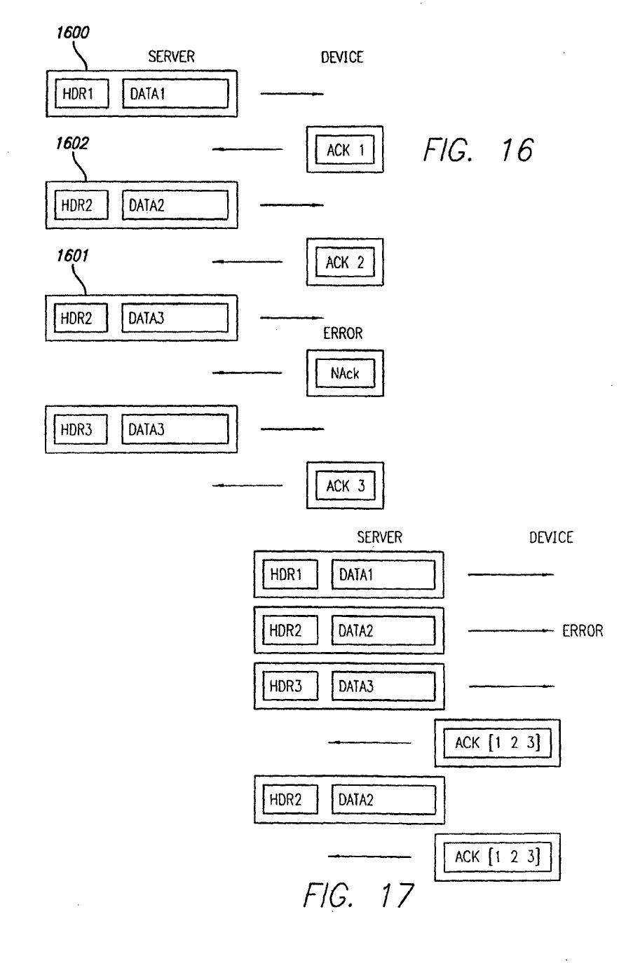

The system 100 allows for storage of a large number of clip files in the chip's memory. The system's server 106 utilizes a music compression algorithm, shown in FIG. 15, which converts common music files into compressed files that are downloaded and stored by the chip 106. For example, a chip supporting the storage of about 1000 clips, each being approximately a few minutes in length, may have a flash memory size of about 40 Mbytes. The chip 104 may also have a sound output element such as speakers.

The server comprises software, which can run under Windows 98, Windows-NT OS, or other suitable system using a voice modem for communications. Additionally, the system may use a single modem or a pool of several modems.

### Preferable Embodiments for a Telephone System

Examples of telephone systems utilizing the method of the present invention include a cellular phone, which may utilize an analogue (voice-only) system or a digital system, and a conventional landline telephony network. A system for using a cellular network infrastructure is shown in FIG. 2. A schematic diagram of a landline transmission system for a home telephone is shown in FIG. 12. (Again, although the following descriptions make reference to the use of sound clips, it is to be understood that entire sound files may also be used as described.)

All described examples assume existence of a server preferably dedicated for servicing user requests and providing sound clip data download capabilities. A corresponding chip, implementing all required functions is associated with the telephone.

The server may be a computer running Microsoft Windows or other suitable environment, such as a Pentium-I11 PC, Win95/98/NT/2000,128 Mb RAM, 4 GB HDD. The server may store or be capable of accessing a sound clip database, which may be stored on a website of non-web holding unit. The sound clip database is stored in a compressed file format of those commonly known.

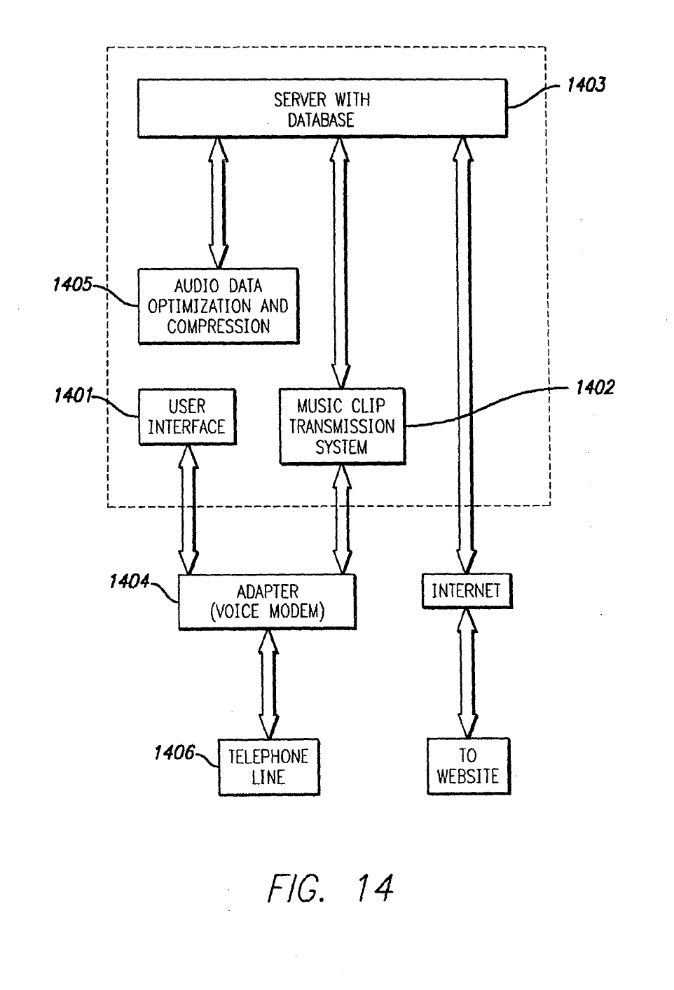

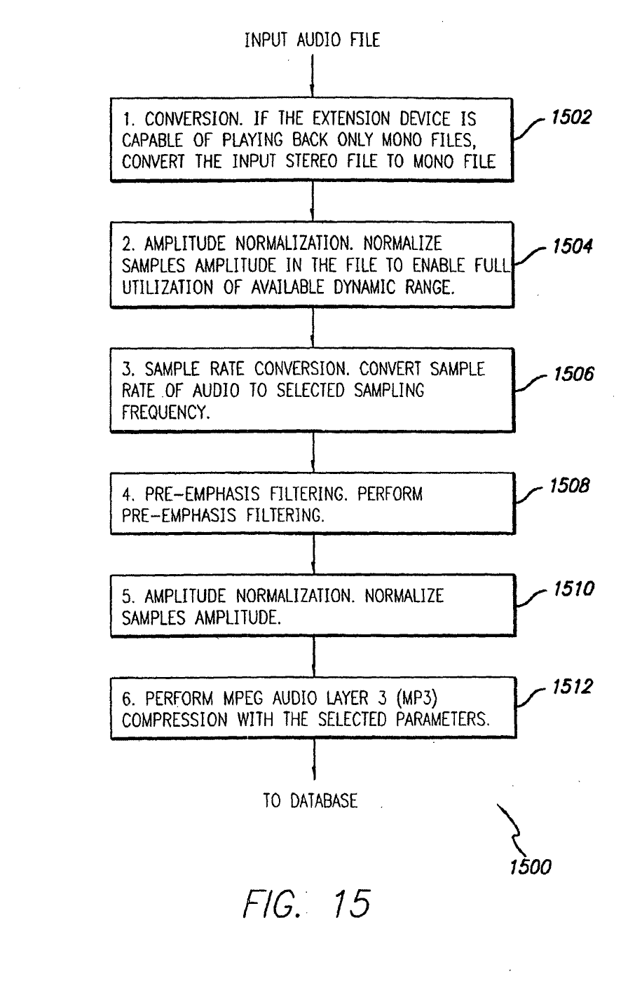

A schematic diagram for a server software system is shown in FIG. 4 for a cellular phone system, and FIG. 14 for a landline system. The software may be written in C++ under Microsoft Windows or other suitable language. The functions of the server software include servicing user requests via a user interface element and transmitting a selected sound clip through the phone line via a music clip transmission element.

According to a preferred embodiment, the functions of the user interface element include decoding DTMF keys pressed by the user and playing the voice menu labels to the user. The voice menu interface may include hierarchical submenus, leading to different functions. In all examples, the user interface element can be unified in the sense that the voice interface and DTMF or voice recognition-based interface are independent of the type of network or type of phone(s) used. Implementations that utilize a single server to process requests originating from different types of networks and/or phones can therefore be built.

The system of submenus leads a user to the downloading of the selected sound clip. Thereafter, control is transferred to the music clip transmission element for downloading sound clips into the phone. The music clip transmission element interfaces directly with the phone accessory unit, independent of the user. The music clip transmission element is dependant on the type of the phone used and the network infrastructure.

### Example Transmission System for a Cellular Phone and Network

FIG. 2 is a schematic diagram of a wireless transmission system 200 for a cellular phone 202, which may be either an analogue (voice-only) or digital system. In both cases, a specialized board 203, implementing all required functions, similar to the chip 104, is incorporated in an accessory unit 204 attached to the cellular phone. Although the system 200 is described as incorporating an accessory unit, it should be understood that a chip performing the same functions of the board may instead be embedded in the phone itself, or a software system may be integrated with the existing hardware chip of a conventional cellular phone without the need for additional hardware. The system 200 further includes a server 206 and software 207 for the server.

The cellular telephone 202 may be any commercially available cellular phone having capabilities for supporting a command set for general telephone control, [i.e., a V.25TeT serial asynchronous automatic dialing and control as recommended by the ITU-T (International Telecommunications Union-Telecommunications sector)] and for supporting V.25Ter “+C” extensions according to the ETSI (European Telecommunications Standards Institute) ETS-300916 standard for obtaining codes of keys pressed by the user and for receiving caller ill information. Additionally, the phone 202 should have capabilities for subscribing to a cellular provider 208 with caller ill service support.

A schematic diagram of the board 203 is shown in In an embodiment where an accessory unit is used the board 203 is implemented in the accessory unit 204 which can be attached to the phone 202 through a standard extension connector where other commercially available accessories such as hands free ear set and charging adapter are typically connected.

The board 203 includes the following main blocks: a Digital Signal Processor (DSP) 300, a flash memory element 302, a Random Access Memory (RAM) element 304, an initial bootstrap chip 306, an analogue interface element 308, and a digital interface element 310.

The processor 300 executes the device firmware, provides control for all other blocks and performs the computational tasks for the board 203. The tasks performed by the processor 300 include control of the board's units, monitoring of keys pressed by the user and processing key-press events, reception of information from the computer through the computer digital interface, reception of caller ill information through the phone digital interface, reception of packed sound clips through the phone analogue or digital interface, unpacking and then playing back sound clips through a built-in speaker connected to the analogue interface of the accessory unit 204, support of a voice menu-driven user interface, and performance of other auxiliary functions.

The flash memory element 302 contains the device firmware, and sound clips which can be pre-loaded as well as downloaded from the server. The RAM element 304 enables the processor to run faster and also holds buffers for unpacked sound fragments and processor service procedures. When the power is turned on, the initial bootstrap chip 306 loads the device.

The analogue interface element 308 includes a phone interface element 312 and a built-in speaker interface element 314. The phone interface element 312 is used for input and output of signals when downloading sound clips from the server 206. The speaker interface element 314, with the speaker, plays all system sounds heard by the user including voice menus and sound clips.

The digital interface element 310 includes a phone interface element 316 and may include a computer interface element 318. The phone interface element 316 is used for phone control and for receiving key codes and caller ill information from the phone. The computer interface element 318 is used for various service functions such as downloading preprogrammed sound clips from the computer to the flash memory.

The functions of the server software, shown in FIG. 4, include servicing a user's requests via a user interface element 402 and transmitting a selected sound clip through the phone line 404 via a music clip transmission element 406.

A user interface element 402 is provided whose functions include decoding DTMF keys pressed by the user and playing the voice menu labels to the user. The voice menu interface may include hierarchical submenus, which lead to the downloading of the selected sound clip. Thereafter, control is transferred to the music clip transmission element 406 for downloading sound clips into the phone. The music clip transmission element 406 interfaces directly with the phone accessory unit, independent of the user.

The selected sound clip may be transmitted through the phone line to the accessory unit 204 first through the server hard drive 408, then through the server software 207, next through the voice adapter 210, and through the analogue interface 308 of the accessory unit 204, then through the processor 300 of the accessory unit 214, and finally, through the flash memory element 302 of the accessory unit 204. When the sound clip transmission is completed, the task of music clip transmission element is completed. Thereafter, the phone line 404 is released and control is transferred to the user interface element 402.

In an autonomous mode, the board 203 may contain a number of pre-loaded sound clips. Initially, the board 203 is in inactive state. The board 203 and phone 202 interact such that the phone sends to the board codes of all the keys pressed by the user. Upon receiving a particular sequence of codes for when, for instance, a particular key is pressed for a prolonged period of time, the board 203 switches to the active mode. In the active mode the board 203 may interact with the user via a voice menu-driven interface where voice messages, via a speaker, prompt the user to respond by pressing a selection of phone keys indicating the user's responsive selections. The board 203 reacts to the user's selections by analyzing the keys being pressed.

The clips are stored on an internal clip index, which can be retrieved from the internal memory and played back according to key commands provided by the user. Examples of voice menu options provided by the device 204 through the speaker upon switching to an active mode include: 1) the user may choose to exit the active mode and enter the passive mode (e.g., by pressing “0”); 2) the user may choose to listen to the current sound clip on the clip index (e.g., by pressing “1”); 3) the user may choose to listen to the next clip in the index (e.g., by pressing “2”); 4) the user may choose to listen to a previous clip on the index (e.g., by pressing “Y”); or 5) the user may choose to assign a caller ID number to the current clip on the index (e.g., by pressing “4”).

Upon choosing to assign a caller ID phone number to the current clip, the device may switch to a sub mode with a sub-menu having the following options: 1) the user may choose to switch back to the previous menu (e.g., by pressing “0”); 2) if the selected clip was already assigned, the user may choose to get information regarding the caller ID already associated with the clip (e.g., by pressing “1”); or 3) the user may input a new caller ID phone number for the current clip (e.g., by pressing “T” indicating this choice, then dialing in the phone number followed by the “#” sign).

In the passive mode, the device 204 may analyze messages being retrieved from the telephone 202. Upon receiving an incoming call, the device 204 checks the incoming caller's phone number against the list of assigned caller ID sound clips in its memory and plays back the particular sound clip through the built-in speaker if the specified caller's phone number was assigned to this clip. Alternatively, the device 204 may play back a default sound if the particular caller ID was not assigned to any clip.

In order to transfer digitally Compressed sound clip data through the analogue channel a special method and algorithm to map digits to sounds is used. This method is implemented not only for a cellular telephone using an analogue cellular network but also for a landline transmission system of a home phone, shown in FIG. 12.

### Method for Data Transmission Over an Audio Channel of a Wireless Telephone

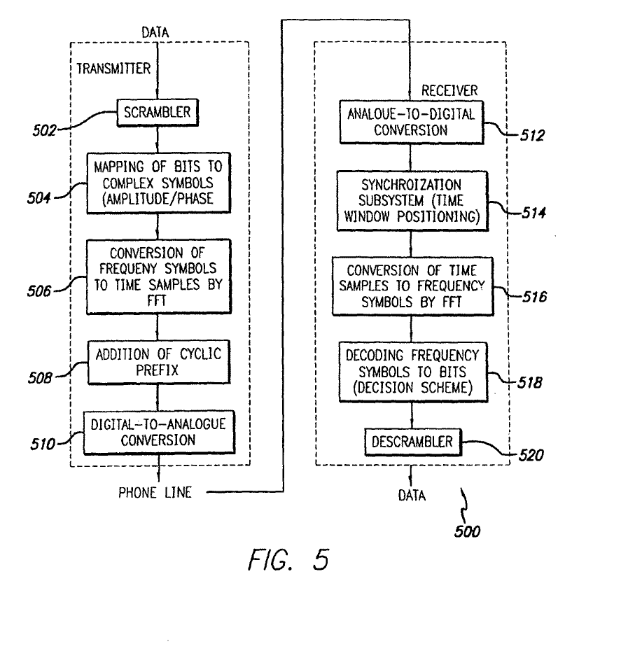

A data transmission method 500 for transferring data through the phone line and the receiver, based on a voice mode connection (versus data mode) and DTMF signal interpretation is illustrated in FIG. 5. A similar approach can be implemented for a landline telephone that does not have a data transmission mode.

For transmitting data through the phone line, the transmission method 500 comprises a) data scrambling 503, b) data mapping 504, c) conversion of frequency symbols to time samples 506, d) addition of cyclic prefix 508, and e) digital to analogue conversion 510. The data is then sent through the receiver, following the reverse steps of f) analogue to digital conversion 512, g) symbol synchronization 514, h) conversion of time samples to frequency symbols 516, i) decoding frequency symbols to bits 518, and j) de-scrambling the data 520.

The transmission method is used to provide enough speed for the data transmission. The transmission method allows simultaneous use of the voice communication and data transmission features (during one connection session) without having to switch the mode of connection. A customer does not need to use a Wireless Internet Service Provider. A user can simply place a regular call to the specific number (e.g., an “800” number) to gain access to the Server. The dual-mode connection allows for voice and “push button” support as well as voice recognition service.

An orthogonal frequency-division multiplex (OFDM) modulation scheme is used for data transmission. The benefits of OFDM include: 1) the modulation can be made robust to Inter-Symbol Interference (ISI) by increasing symbol size; 2) the modulation can be made robust to impulse noise by increasing symbol size; 3) for each individual sub-channel, the channel's response could be considered essentially flat, minimizing the need for channel equalization; and 4) different encoding schemes could be used for different sub-channels, for accommodating frequency-selective channel distortions.

The total bandwidth to be used by the method is determined by the worst case of supported audio channel. A suitable algorithm for compression of the voice channel is the GSM RPE-LTP algorithm which essentially has a built-in down-sampling by a factor of 3 in which the allowed bandwidth is limited at 4000/3=1333 Hz. Usually channel response is severely limited at frequencies below about 200 Hz to 250 Hz. No OFDM symbol time-windowing is employed to minimize variations of transmitted signal amplitude envelope.

A compressed voice channel can, also introduce significant non-linear distortions. Therefore, it is not feasible to have a large number of sub-channels; otherwise the algorithm would be affected by significant inter-channel interference (ICI) due to loss of orthogonality between sub-channels. About 32 sub-channels appear to provide enough symbol size while maintaining satisfactory low ICI.

### Modulation Symbol Structure

Each OFDM symbol consists of a minimum number of samples sufficient to represent all sub-channels. To increase computation efficiency, a Fast Fourier Transform is employed to convert sub-channel symbols from frequency to time area. Therefore, for 32 sub-channels, OFDM symbol size should be at least 64 real samples (at 2666 Hz rate). A circular prefix of 16 samples is used to improve separation between symbols, and minimize ISI (Inter Symbol Interference) and ICI. Therefore, total symbol size is 80 samples at 2666 Hz.

### Receiver Synchronization

Circular extension prefix redundancy, present in the signal, is used to facilitate OFDM symbol synchronization in the receiver. A synchronization subsystem effectively computes auto-correlation coefficients of the received sequence (e.g., at 2666 Hz). The output of the correlator goes through a “rectifying” phase-locked loop-like system, which outputs synchronization impulses at the proper time instants to sample OFDM, symbols correctly.

Synchronization system inducted timing jitter leads to rotation of receive sub-channel phasors b increments, proportional to the central frequency of a particular sub-channel. This rotation is compensated in the decision scheme.

### Data Mapping

The output of a scrambler is mapped onto complex symbols (amplitude/phase) of the OFDM sub-channels, Individual sub-channels use QPSK (Quadrature Phase Shift Keying) modulation.

### Data Scrambling

Data scrambling is employed in order to provide statistically random distribution of transmitted symbols to reduce peak-to-average power ratio of OFDM symbols. A self-synchronizing scrambler with generating polynomial of 1+X−(18)+X−(23) is used, which at the transmitter, effectively divides the data sequence by the generating polynomial. The coefficients of the quotients, taken in descending order, form the output data sequence.

### Example Using Analogue Cellular Network and Cellular Telephone

The above-described accessory unit 204 is provided in this example in the context of analogue (providing only voice channel) cellular network.

Initially, the device 204 is in an inactive mode. A user dials the server number and, navigating through a system of voice menus supported by the server software, listens to and selects a particular sound clip in the same way as browsing the loaded sound clips in the autonomous mode. Instead of assigning a caller ID, the user may choose to download sound clips.

When a user, navigating through the server voice menus, selects to download the current clip and in the embodiment using an accessory unit activates the accessory unit 204 through the predefined key sequence, the process of transmission of the selected sound clip is initiated. After selecting a “download” option, the user may press a specific key combination on the phone to switch the accessory unit 204 from the inactive to the active mode. The unit 204 then begins to interact with the server 206, using the analogue channel provided by the phone and network. The already established phone connection is used to receive information. The device may receive the sound clip selected by the user and download it into internal flash memory.

At the end of a session, the unit 204 forces the telephone 202 to hang up and switches to the autonomous mode, which enables the user to assign a new caller ID to the sound clip just received. When a user, navigating through the server voice menus, selects to download a clip and activates the accessory unit 204 through the pre-defined key sequence, the process for transmission of the selected sound clip is initiated.

The selected sound clip is transmitted through the phone line to the accessory unit 204 first through the server hard drive 408, then through the server software 207, next through the voice adapter 210, then through the phone line of the network to the cellular service provider 208, to the cellular phone 202, and through the analogue interface 308 of the accessory unit 204, then through the processor 300 of the accessory unit 204, and finally, through the flash memory element 302 of the accessory unit 204.

Generally, the server software 207 retrieves the selected sound clip from a database 212, converts it to the special sequence of sounds modulates, transfers codes of these sounds to the voice adapter 210 that converts these codes to actual sounds and transfers these sounds to the phone line 214. From the phone line 214, the sounds go to a cellular provider 208 through to a radio channel and to the cellular phone 202 itself (much like voice sounds are transferred during a normal phone conversation). The sounds then go through the connector and are received in analogue form by the board 203. The sounds are then converted by the device ADC (Analog to Digital Converter) to the digital form and are processed by the DSP (digital signal processor “demodulated”) 300 to the same digital data form initially stored on the database 212 (e.g., in MPEG audio format). In this form, the sound clip data are written into the flash memory 302 of the device 204.

Following a reverse direction, going from the board 203 to the server 206 using the same chain, the device sends to the server either an “acknowledgment” of a successful delivery of the sound clip data or a list of data blocks received with errors so that these blocks can be resent in a second try. In order to transmit digital data through the analogue channel, a similar procedure is used to convert data to sounds and back.

When all the data is transferred without errors, the board 203 signals to the server 206 that the call may be disconnected. Thereafter, the server 206 instructs the voice adapter 210 to hang up, freeing the phone line for another client, and the board 203 switches to the autonomous mode, allowing the user to assign a caller ID to the sound clip most recently downloaded.

### Examples Using Digital Cellular Network and Cellular Telephone

The above-described accessory unit 204 is used in this example in the context of digital (capable of providing a dedicated data transmission channel) cellular network. Since in this case a digital channel is used for sound clip data transmission, no modulation is required on the mobile phone side. The server, on the other hand, uses a modulation protocol compatible with the protocol supported by the cellular network provider. Usually this can be accomplished by using a standard ITU-T approved modem, like V.32 or V.34.

Initially, the unit 204 is in an inactive mode. A user dials the server number and, navigating through a system of voice menus supported by the server software, listens to and selects a particular sound in the same way as browsing the loaded sound clips in the autonomous mode. Instead of assigning the caller ill, the user may choose to download sound clips.

When a user, navigating through the server voice menus, selects to download the current clip and activates the accessory unit 204 through the pre-defined key sequence, the process of transmission of the selected sound clip is initiated. After selecting a “download” option, the user may press a specific key combination on the phone to switch the accessory unit 204 from the inactive to the active mode. The unit 204 then begins to interact with the server 206, using the digital channel provided by the phone and the network. If possible, the already established phone connection is used, or a new connection is established specifically for digital data transmission.

The selected sound clip is transmitted through the phone line to accessory unit 204 first through the server hard drive 408, then through the server software 207, next through the voice adapter-modem 210, then through the phone line of the network to the cellular service provider 208, to the cellular phone 202, and through the digital interface of the accessory unit 204, then through the processor 300 of the accessory unit 204, and finally, through the flash memory element 302 of the accessory unit 204.

Generally, the server software 207 retrieves the selected sound clip from a database 212, transfers codes of these sounds to the voice adapter-modem that converts these codes to actual sounds, using one of the standard modulation protocols supported by the cellular provider (like ITU-T V.32 or V.34) and transfers these sounds to the phone line 214. From the phone line 214, the sounds go to a cellular provider 208, where they are demodulated back into digital data and then the data goes to the cellular phone 202, through the radio channel, using the digital channel provided by the cellular network. The data is then received by the processor of the accessory unit, and then written into the flash memory 302 of the device 204.

Following a reverse direction, going from the board 203 to the server 206 using the same chain, the device sends the server either an “acknowledgment” of a successful delivery of the sound clip data or a list of data blocks received with error so that these blocks can be resent in a second try. When all the data is transferred without errors, the board 203, signals to the server 206 that the call may be disconnected. Thereafter, the server 206 instructs the voice adapter-modem to hang up, freeing the phone line for another client, and the board 203 switches to the autonomous mode, allowing the user to assign a caller ill to the sound clip most recently downloaded.

In order to provide a guaranteed and error-free delivery of digitally compressed sound clip data through the data channel provided by the phone and network, a special error detection and correction method is proposed.

A Data Transmission Method with Error Correction Delivery

A method for data transmission with error correction assumes sufficiently low probability of error in the channel and implements error correction by re-sending the affected data blocks. The data (i.e., the compressed sound clip) is split into smaller data blocks by the server. Each block is supplied with a special header that, in particular, includes the block number and a cyclic redundancy code word for error detection, computed for the block data and header. Other error detection codes can also be utilized. The data blocks are then sent through the data channel sequentially. Using the redundancy code, the receiver (i.e., the mobile device) checks the correctness of each received block. The size of blocks is selected in such a way that 1) there is a high probability of error-free transmission of a block; and 2) the overhead introduced by additional control information (e.g., header, CRC word) is not high compared to the data payload.

If the block size is selected properly, only a few blocks out of the entire sequence are usually affected by channel errors. These erroneous data blocks are re-sent by the Server upon receiving special requests.

Depending on the availability of bi-directional data transfer, one of two protocols can be used. If the phone and network support simultaneous transmission of data in both directions, a protocol that uses simultaneous transmission of data in a server-to-phone direction and acknowledgments in a phone-to-server direction can be utilized. In this case, a special acknowledgment packet is sent for each valid data block received by the device. If a block is received with an error, a negative acknowledgment packet is sent.

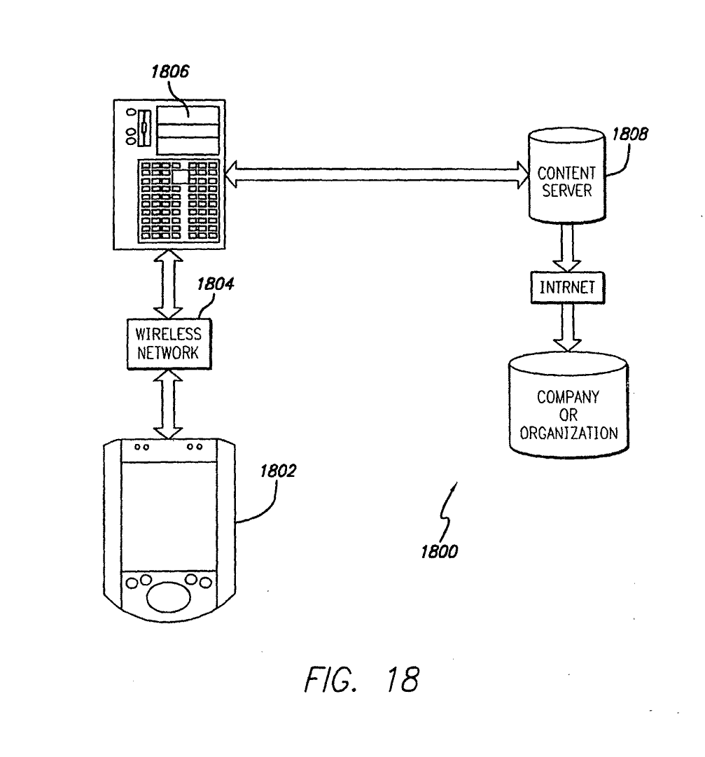

The server software, receiving these control packets, either sends the next subsequent data block, until all data blocks are transferred, or resends the block received with error. When all data blocks are transferred, and the positive acknowledgment is received for the last block, the sound clip is considered to be completely delivered. An example of such interaction is shown in FIG. 16 for protocol with individual packet acknowledgment for full-duplex channel, showing three data blocks 1600, 1602, and 1604 for corresponding data, indicated in the figure as “Data1”, “Data2” and “Data3”, with corresponding headers “Hdr1”, “Hdr2”, and “Hdr3”. Positive acknowledgments “Ack1” and “Ack2” are sent for packets numbers 1 and 2. Packet number 3 is originally received with an error, indicated by “Nack” and is subsequently re-sent to successfully correct the error, whereby a positive acknowledgment “Ack3” is sent.

If the phone or network supports only unidirectional data transmission, the other protocol can be utilized to minimize the number of channel direction alterations. In this case, the server sends all data blocks for the sound clip at once, without receiving acknowledgments for the individual packets. Then, a single control packet is transferred in the opposite (device to server) direction. This control packet contains a bit mask, with one bit for each data block received. Each bit in the bit mask has a “1” value if the corresponding data block was received without errors, or “0” value if the corresponding block was affected by errors. The server then re-sends those blocks that were received with errors in the first pass. When all data blocks are transferred, and the server receives the acknowledgment mask without errors indication, the sound clip is considered to be completely delivered. Example of such interaction is shown in FIG. 17, where the packet number 2 is originally received with an error and is successfully resent subsequently to correct the error. Note that only two “ACK” packets were sent during the entire procedure.

### Example Using Landline Telephony Network and a Conventional Home Telephone

FIG. 12 illustrates an example of a landline telephony network system 1200 using a voice channel and a conventional home telephone 1201, according to a preferred embodiment. (Although this system is described with respect to the accessing and delivery of sound clip files, it is to be understood that the system may be used for the accessing and delivery of entire files).

The system 1200 has two main components: a home telephone accessory unit 1202 and a server 1205. The accessory unit 1202 is an autonomous unit, attached to the phone line 1208 and to the phone (between the line and the phone), and powered from the AC power outlet. A chip performing the same function of the accessory unit may instead by embedded in the phone itself The purpose of the accessory unit 1202 is to support selection, downloading, and playback of sound clips according to the Caller ID of the calling subscriber. The accessory unit 1202 may include a speaker system and enables the phone to ring sound clips or perform other functions as described for the cellular phone 102.

The server 1205, which is associated with stored clip files 1206, which may be stored on a website or a non web holding unit, is designed to execute requests of the accessory unit 1202 either through the user voice commands or commands using the phone keys, and allows for files to be transmitted to the accessory unit 1202 for storage. The system 1200 enables a connection to the server upon a request from the from the accessory unit 1202, utilizing the phone and PSTN (Public Switched Telephone Network), and an adapter 1204 (voice modem) attached to the server computer. The system 1200 may have a voice menu, which, after connection to the server, allows the user to listen to the server's menu and navigate through the system of voice menus using the phone's DTMF keys. The system may allow the user to select and download clips by allowing the user to listen to the clips presented by the server, select a clip, and issue a download command to the server. The server then sends the selected clip (e.g., in digital compressed form) using the Custom Data Transmission Protocol (CDTP) over the voice channel.

The device 1204 may further interface with a home PC 1214 for downloading sound files to the device. The interface may be a plug in connection or may use a wireless network system.

The accessory unit 1204 may be sold as a unit compatible to most home phones including cordless phones, and may connect directly to the phone jack, with the phone connected to the device. Similar to the cellular phone 102, a home phone may include an embedded chip, instead of the accessory unit 1204, for performing functions similar to those of accessory unit 1204.

The handset of a cordless phone utilizing sound clips according to the present invention may ring simultaneously with the box, wherein the handset may sound a regular phone ring or a sound clip ring, while the box plays a sound clip ring.

The server comprises software shown in FIG. 14, which can run under Windows 98®, Windows-NT OS®, or other suitable system using a voice modem for communications. Additionally, the system may use a single modem or a pool of several modems.

Initially, the accessory unit 1202 is in an inactive mode. A user dials the server number and, navigating through a system of voice menus supported by the server software, listens to and selects a particular sound clip in the same way as browsing the loaded sound clips in the autonomous mode. Instead of assigning a caller ID, the user may choose to download sound clips.

When a user, navigating through the server voice menus, selects to download the current clip and activates the accessory unit 1202 through the pre-defined key sequence, the process of transmission of the selected sound clip is initiated. After selecting a “download” option, the user may press a specific key combination on the phone to switch the accessory unit 1202 from the inactive mode to the active mode. The device 1202 then begins to interact with the server 1205, using the analogue channel provided by the telephone and the network. The already established phone connection is used to receive information.

The selected sound clip is transmitted through the telephone line to the accessory unit 1202 first through server 1205, next through the adapter 1204, then through the telephone line of PSTN to and through the analogue interface 1305 of the accessory unit (shown in FIG. 13), then through the processor 1301 of the accessory unit 1202, and finally, through the flash memory element 1302 of the accessory unit 1202.

A schematic diagram of a board 1300 implemented in the accessory unit 1202 is shown in FIG. 13. The board includes the following main blocks: a processor element 1301 [e.g., a Digital Signal Processor (DSP)], a flash memory element 1302, a Random Access Memory (RAM) element 1303, a bootstrap 1304, an analogue interface element 1305, and a digital interface element 1306.

The processor 1301 executes the device firmware, provides control for all other blocks and performs the computational tasks for the board. The tasks performed by the processor 1301 include: control of the board's units, monitoring of keys pressed by the user and processing of key-press events, reception of information from the computer through the computer digital interface, reception of caller ID information from telephony service provider, reception, of sound clips through the phone analogue interface, unpacking and then playing back sound clips through a built-in speaker connected to the analogue interface of the accessory unit 1202, support of a voice menu-driven user interface, and performance of other auxiliary functions.

The flash memory element 1302 contains the device firmware, and the sound clips which can be pre-loaded as well as downloaded from the server. The RAM element 1303 enables the processor to run faster and also holds buffers for unpacked sound fragments and processor service procedures. When the power is turned on, the bootstrap chip 1304 loads the device.

The Analogue Interface element 1305 includes a telephone interface element and a built-in speaker interface element. The telephone interface element is used for input and output of signals when downloading sound clips from the server 1205. The speaker interface element with the speakers plays all systems sounds heard by the user including voice menus and sound clips.

The digital interface element 1306 may include a computer interface element and other digital interface elements to the home network. The computer interface element may be used for various service functions such as downloading preprogrammed sound clips from the computer to the Flash Memory.

In an autonomous mode, the accessory unit 1202 contains a number of pre-loaded sound clips. Initially, the accessory unit is in the inactive state. The accessory unit 1202 and telephone 1201 interact such that the telephone 1201 sends to the accessory unit 1202 codes of all the keys pressed by the user. Upon receiving a particular sequence of codes or when, for instance, a particular key is pressed for a prolonged period of time, the accessory unit 1202 may switches to the active mode. In the active mode, the accessory unit 1202 may interact with the user via a voice menu-driven interface where voice messages, via a speaker, prompt the user to respond by pressing a selection of phone keys indicating the user's responsive selections. The accessory-unit 1202 reacts to the user's selections by analyzing the keys being pressed.

In the passive mode, the accessory unit 1202 may analyze messages being received from the telephone 1201. Upon receiving an incoming call, the accessory unit 1202 checks the incoming caller's phone number against the list of assigned caller ID sound clips in its memory and plays back the sound clip through the built-in speakers if the specified caller's phone number was assigned to this clip. Alternatively, the accessory unit 1202 may play back a default sound if the particular Caller ID was not assigned to any clip.

A schematic diagram of the server software is shown in FIG. 14. The server software is used to servicing user requests through user interface element 1401, and transmitting the selected sound clip through the phone line via music clip transmission element 1402. The user interface element 1401 decodes DTMF keys pressed by the user, and plays voice menu labels to the user. The voice menu interface includes hierarchical submenus to lead the user to the downloading of the desired sound clip, where control is transferred to the music clip transmission element 1401.

The music clip transmission element 1401 downloads sound clips to the phone, independent of the user interface element, interfacing directly with the phone accessory unit. The music clip transmission element 1402 initially transmits the selected sound clip to the adapter 1404 for data transmission from the server to the accessory unit. When the sound clip transmission is completed, the task of the music clip transmission element is done, and the telephone line is released and control is transferred to the user interface element 1401.

Generally, the server software retrieves the selected sound clip from a server database 1403, which is associated with an audio data optimization and compression element 1405, converts the clip to the special sequence of sounds modulates, and transfers codes of these sounds to the adapter 1404 which converts these codes to actual sounds and transfers these sound to the phone line 1406. From the phone line 1406, the sounds go through the PSTN and are received in analogue form by the accessory unit 1202. The sounds are then converted by the device ADC (Analog to Digital Converter) to the digital form and are processed by the DSP (digital signal processor) 1301 to the same digital data form initially stored in the server database 1403 (e.g., in MPEG audio format). In this form, the sound clip data are written into flash memory 1302 of the accessory unit 1202.

Following a reverse direction, going from the accessory unit 1202 to the server 1205 using the same chain, the device sends to the server either an “acknowledgment” of a successful delivery of the sound clip data of a list of data blocks received with errors so that these blocks can be resent in a second try. In order to transmit digital data through the analogue channel, a similar procedure is used to convert to data to sounds and back. When all the data is transferred without errors, the accessory unit 1202 signals to the server 1205 that the call may be disconnected. Thereafter, the server 1205 instructs the adapter 1204 to hang up, freeing the phone line for another client, and the accessory unit 1202 switches to the autonomous mode, allowing the user to assign a Caller ID to the sound clip most recently downloaded.

The server audio data optimization and compression element 1205, utilizes a MUSIC compression algorithm outlined in FIG. 15, which converts common music files into compressed files in order to reduce the audio clip size for minimizing its download time, while maintaining predetermined audio quality. These files are downloaded and stored by the accessory unit 1202.

### Preferred Procedures for Audio Data Parametric Optimization and Compression

The method 1500 of compressing the files comprises a) conversion 1502; b) amplitude normalization 1504; c) sample rate conversion 1506; d) pre-emphasis filtering 1508; e) amplitude normalization 1510; and f) performance MPEG audio layer 3 (MP3) compression with the selected parameters 1512. The compressed files are then transferred to the server database.

Step 1502 of conversion to mono only needs to be performed if the input file is in stereo and if the audio output subsystem of the target hardware is only capable of playing back mono audio. At this step all available information is included into the output audio by summoning of the left and right channels to form a single mono output.

After conversion, or if the file does not need to be converted to mono, compression begins with the step 1504 of amplitude normalization, wherein sample amplitudes in the file are normalized. This step is required for enabling audio utilization of all available dynamic range and for improving the computational accuracy of subsequent steps. In order to maximize preservation of original audio range, a fixed coefficient for the entire audio file normalization is used. The coefficient is obtained using input file analysis to “stretch” the input audio range over the maximum available range.

Step 1506 converts sample audio files to selected sampling frequency. The original audio clips may have various sampling rates (44100 Hz, 4800 Hz, 22050 Hz, 11025 Hz, etc.). After analysis of available hardware capabilities an optimal sampling frequency, which provides the most adequate audio quality, is selected. Increasing the sampling frequency above the optimal sampling frequency would not significantly increase the perpetual audio quality, due to the limitations of the audio output subsystem of the accessory unit. For example, for the cellular phone system of FIG. 2, after analysis of available hardware capabilities and a series of perceptual tests, the 22050 Hz sampling frequency was selected as providing the most adequate audio quality since the audio output subsystem of the accessory unit has a relatively sharp drop in response for frequencies above 10-12 kHz.

In order to avoid aliasing effects when changing from higher to lower sampling rate, a low-pass pre-filtering with a cutoff slightly lower then the new Nyquist frequency is applied before down sampling. For rates that are not multiples of each other, cascaded sampling rate conversion schemes are constructed to minimize memory consumption and improve performance.

The step 1508 of pre-emphasis filtering, along with re-sampling of the precious stage, takes into account the specifics of the audio output subsystem of the accessory unit, to achieve improvement of the perceptual audio quality, and to reduce the resulting audio size after compression.

Since the speaker of the audio output subsystem of accessory unit is preferably very small, the resulting sound has very low power in the low frequency range. Therefore, providing output in the low frequency range in likely to be futile, as it would only increase the size of audio without any perceptual improvements. Additionally, providing output in the low frequency range may create undesirable “overflow” effects for the speaker.

For example, for the cellular phone system of FIG. 2, all frequency content below about 400 Hz is removed from the audio. In order to make the audio more “perceptually rich” in the low-frequency range, frequencies around 600 Hz are increased by about +6 dB. The frequency range from 1200 Hz to 8200 Hz is kept unchanged. Then, starting from about 8200 Hz the signal power is gradually increased, up to +15 dB at the highest frequency (11 kHz). This compensates for the drop in speaker transfer function at high frequencies and improves the listening experience.

A set of subjective audio perceptual tests with various types of audio contents, using the wide spectrum of hardware of the target platform has proved that the above-described pre-emphasis significantly improves the perceptual quality of resulting audio. At the same time, reducing frequency contents in the “non-significant” frequency regions allows reduction of the resulting compressed audio size, since the data bits are not allocated to non-used frequencies.

The described pre-emphasis procedure is implemented by a filtering with FIR (Finite Impulse Response) filter, according to the formula:

$$Y k = {\sum }_{1 = 0}^{N - 1} biXk - 1$$

Where bᵢ are filter coefficients,
Xₖ is the k-th output audio sample,
Yₖ is the k-th output audio sample.
15 The ai coefficients are fixed and compared for the particular sampling rate and the desired pre-emphasis response curve. The filter can be designed to have a linear phase response (this is actually guaranteed if the ai coefficients are symmetric), which would ensure absence of phase distortions to the audio. Since the delay introduced by tile filter is not harmful for off-line processing, the filter size can be made large to approximate the desired response curve with a high precision.

After completing the step of pre-emphasis filtering, normalization of the sample amplitude is once again performed. Since the filtering significantly changes the signal, the second amplitude normalization step 1510 is required to convert resulting audio “loudness” to some predefined value.

Proceeding to step 1512, the processed audio clip is compressed into an MPEG Layer 3 bit stream. The resulting bit rate (level of compression) can be varied to suit different needs. For instance, it can be made dependant on the source audio clip length, to make the compressed file fit into a pre-defined size. Alternatively, it can be made dependant on the anticipated delivery method (to create, for instance, a “built-in” audio clip of a very good quality, or to make the audio clip of a very small size, for delivery through a slow channel). The compression parameters can also be selected so that the clip delivery time is a constant independent of the actual link transfer rate.

### Technical Description of a Preferred Embodiment for a Cellular Phone Accessory Unit

Electrical Schematics

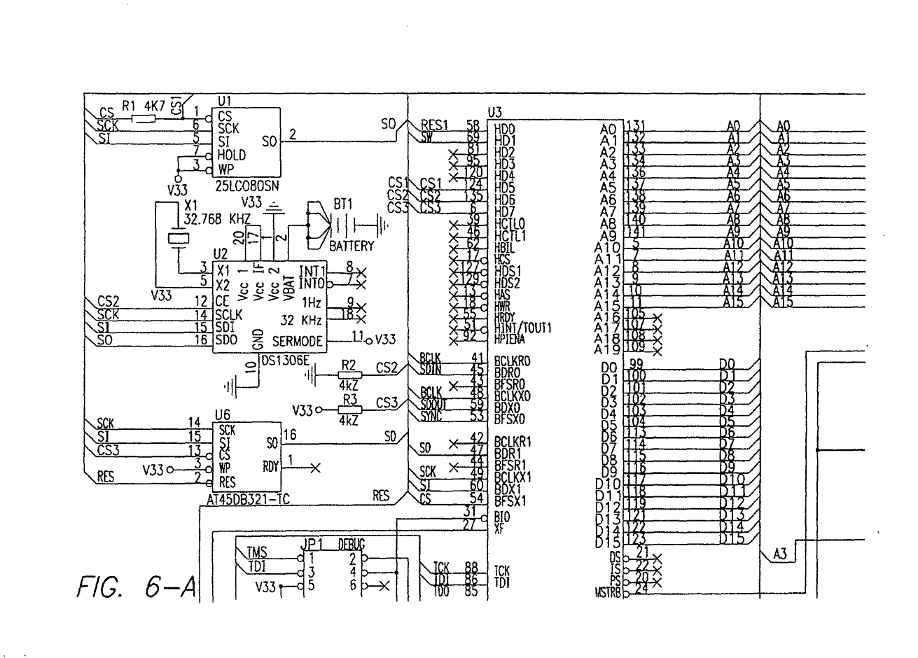

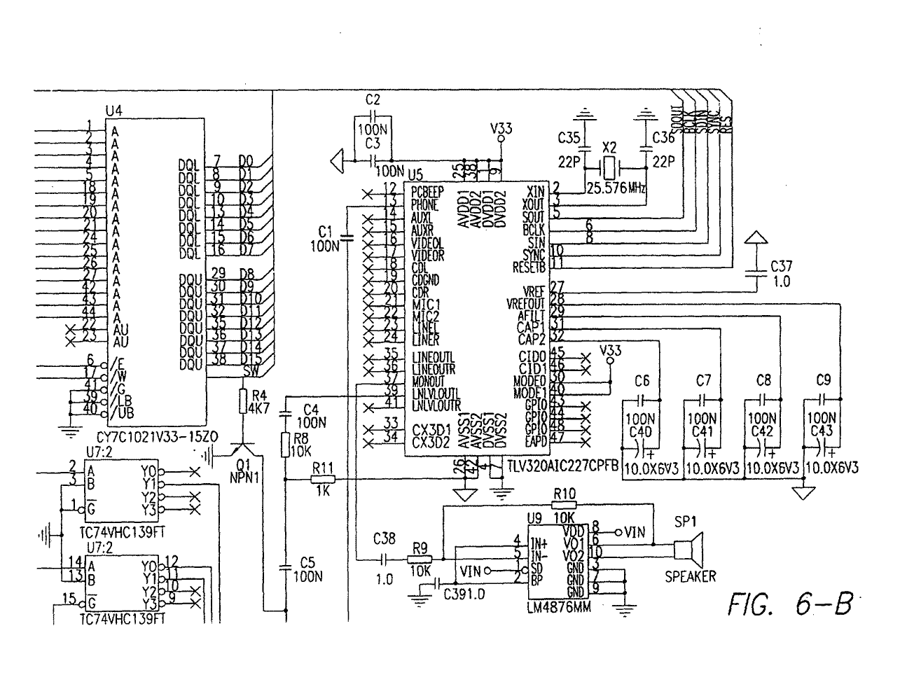

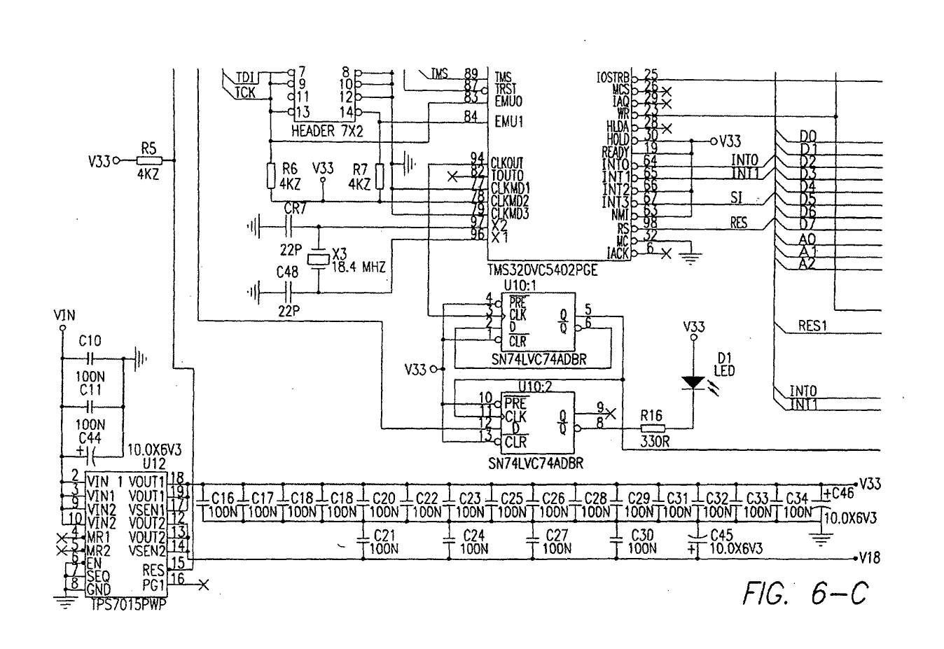

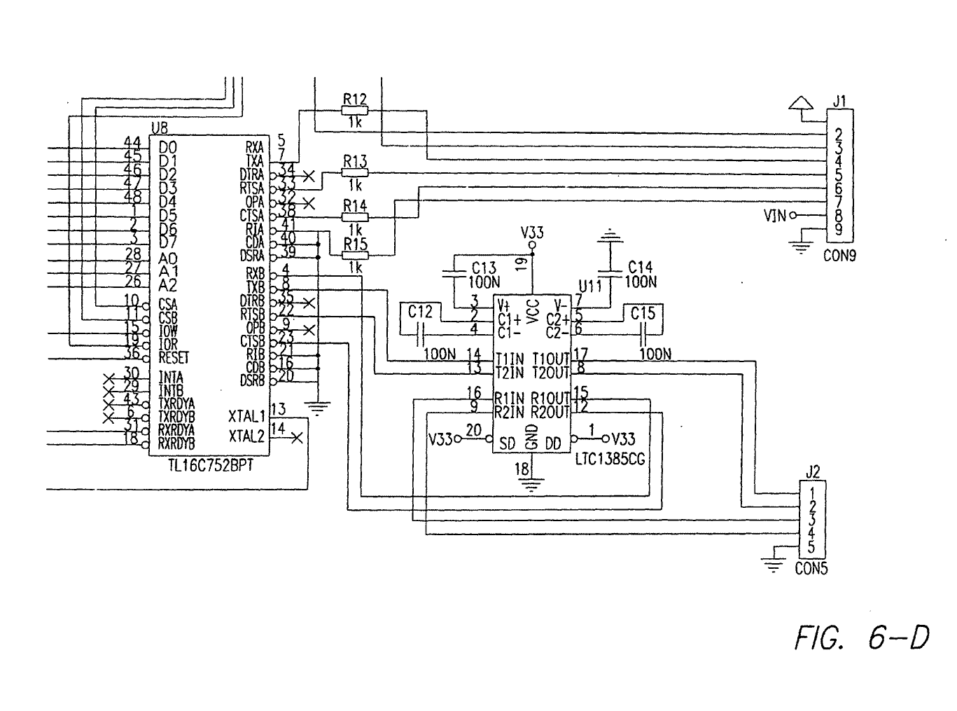

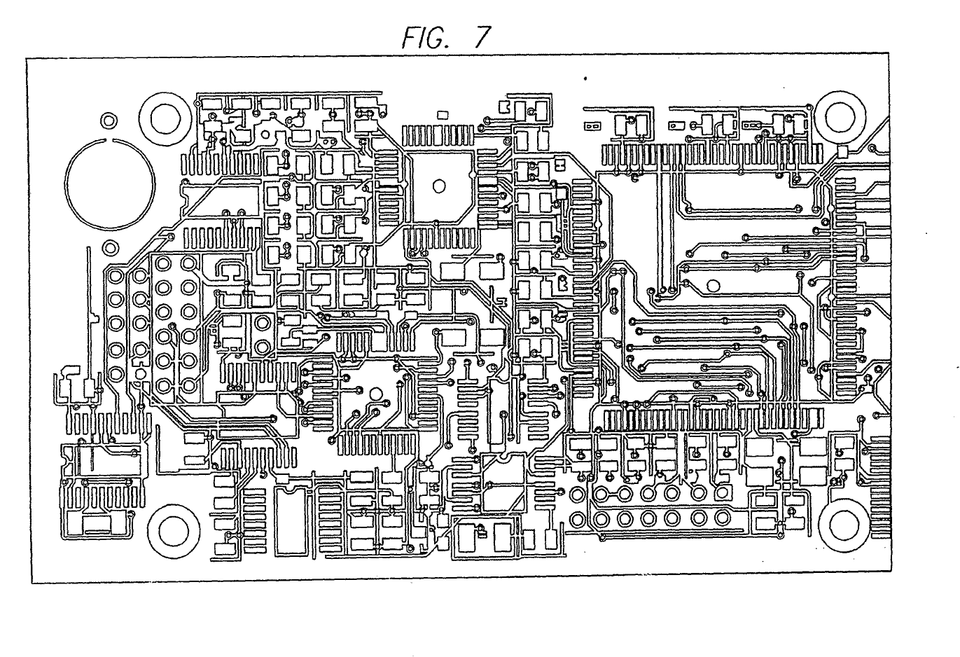

FIGS. 6A-D illustrate the electrical schematics of a mobile phone accessory unit. (The image of the printed circuit board, as rendered by Computer Aid Design Software is shown in FIG. 7). Initial boot-up of the Processor is done from the EEPROM (Electrically Erasable Programmable Read Only Memory) using passive serial SPI (Serial Programming Interface) protocol. Thereafter, the boot loader code, read from the EEPROM, loads the main firmware from the Flash memory. The PLL (Phase Locked Loop) of the processor is programmed for 5x multiplication of clock frequency.

Firmware debugging is carried out through the JTAG (Joint Test Action Group) port using standard TI (Texas Instrument) software. External RAM is mapped both to the program and data space at the same addresses and occupies all lower address space (64 k). Flash memory (Serial Data Flash) is accessed using software emulation of SPI protocol.

Audio code (Coder-decoder) works at approx. 22 kHz sampling rate (both channels). The mode channel transistor selects the phone interface mode: either RS-232 control mode (closed state) or “hands free” mode (opened state). The phone itself does not support simultaneous usage of these two modes.

Both channels of RS-232 work at 11,5200 baud rate. From the PC side CTS (Clear to Send) and DTR (Data Terminal Ready) signals are supported. From the phone side CTS and RTS (Request to Send) signals are supported, with inverted polarities. Both channels employ hardware flow control.

The analogue signal level at the phone input is about 100 m V RMS (Root Mean Square). The level at the phone output is about 600 m V RMS.

Cellular Phone with Accessory Unit

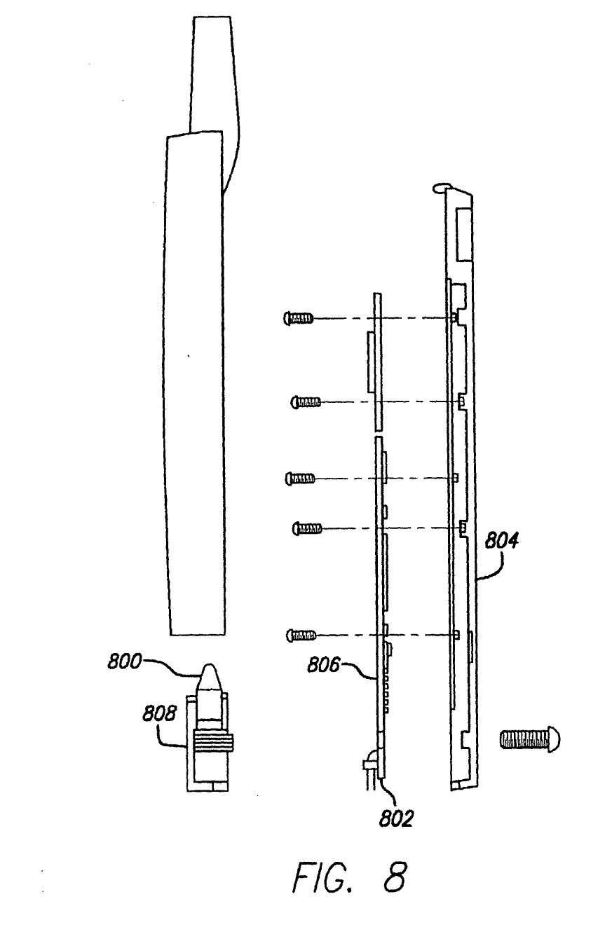

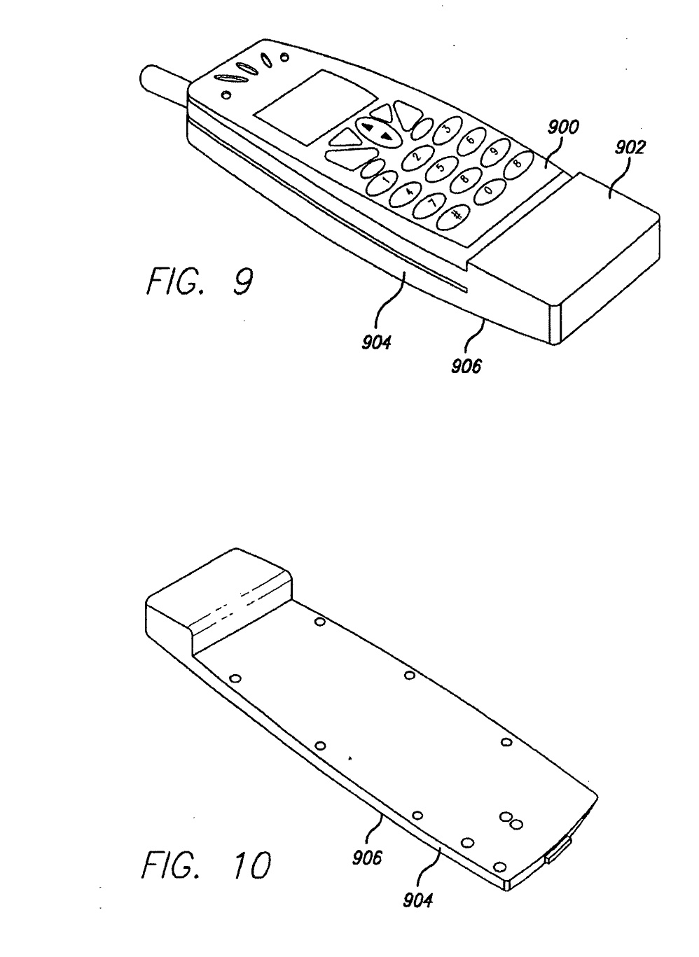

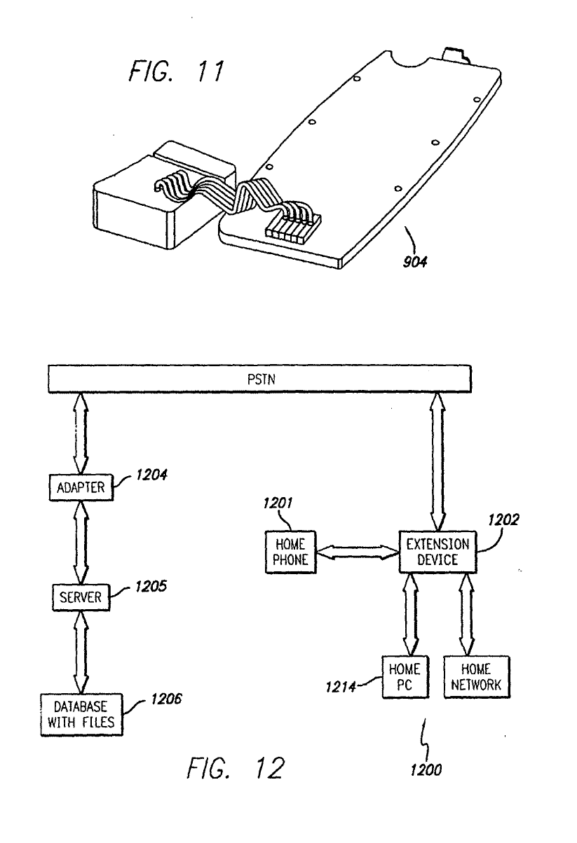

A cellular phone 900 with an accessory unit 902, according to one embodiment, is shown in FIGS. 8 and 9 using the Ericsson R520 as an example. The accessory unit is housed in thin cover 904 (see FIGS. 10 and 11) providing a mounting body 906 for attaching the phone 900 to the unit, via an interface connector 800. The accessory unit contains the printed circuit board 802 and speaker, preferably along the thing portion of the body.

The accessory unit is attached to the back of the phone using the phone connector 800. A snap mounting which utilizes a dimpled section of the phone case typically intended for a car phone holder may also be used.

The accessory unit includes the server software and two voice modems, attached to the server. The mounting body contains all necessary electronic components.

The tasks of the electronic components include playing back of a pre-loaded sound clip upon a caller ID notification reception and downloading new clips from the server.

The body of the accessory unit preferably comprises a base 804, a thin cover 806, and a molded cover 808. All three-body components are preferably made of high quality aluminum-magnesium-copper alloy (duralumin) and are chemically covered with a protective oxide film using two different dyes (colored and black) for the two copies of the device. A dense rubber casing may also be used. Factors considered in selecting the body material include lightness (so that the necessary unit would not exceed the phone itself in weight), mechanical strength, and the quality of electromagnetic shielding properties for protecting the internal components from the waves radiated by the phone.

According to one embodiment, the accessory unit that embodies the delivery system for a cellular phone attachment is about 1.5″×1.5″×0.25″ and includes a small high fidelity built-in speaker. The accessory unit may connect into the AC adapter fixture at the bottom of a cellular phone. A dense rubber casing or glove may house the device to protect it. The inside of the rubber glove may have a molded cavity that the device will fit into. The glove may have a circle of small holes, which line up with the device's speaker to allow full sound penetration. The device and glove may be sold in different design variations for marketing purposes and for fitting the different cellular phones on the market.

Additionally, the accessory unit may connect into a cable connector instead of an AC adapter jack so that different jacks can be used. The device may also be modified with four or five variations to fit the various cellular phone software systems, (not AC adapter variations) currently on the market. The device, including a speaker, may also be made with several different adapter applications that would attach to a variety of different phones.

A snap-on mount for fastening the accessory unit to the phone may be located in the base body. The main purpose of the thin cover is to provide the electromagnetic shielding. The molded cover 808 contains connectors and some other components.

A simple snap mechanism for attaching the accessory unit to the phone, similar to the installation of a cellular phone to a car phone holder, may be provided.

FIG. 10 shows the accessory unit by itself, detached from the phone. The accessory unit can be detached from the phone similar to the detachment of other accessories such as the phone charger (usually by applying a rotating force rather than pulling straight out).

FIG. 11 shows the accessory unit uncovered. It is preferable to leave the body of the accessory unit closed. Preferably, there are no glued, soldered, or other permanent junctions inside, however, the high precision in the manufacture of some components could lead to their degradation after repeated assembly and disassembly.

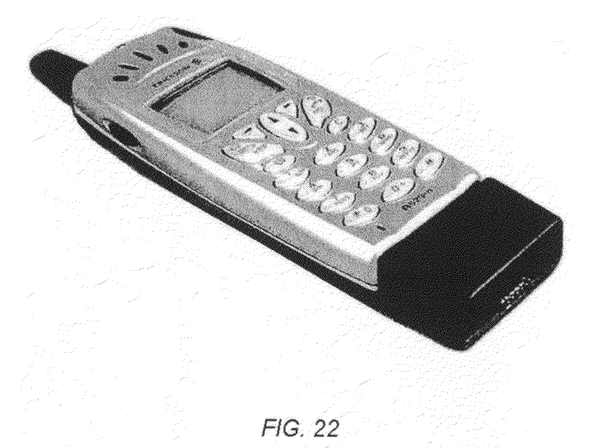

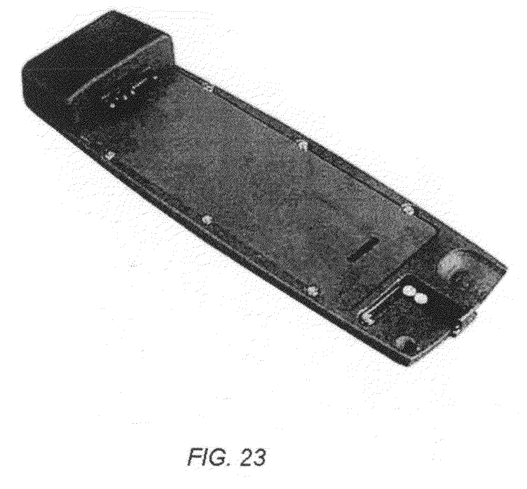

FIGS. 22 and 23 show an electronic device that may be coup able to another device or system to provide the capabilities described above. The device or system may not have the capabilities to accomplish the methods described in exemplary embodiments described herein. The “fish tail” design may be more attractive to users. Furthermore this device may be made of plastics, metals, and other materials, or combinations thereof.

The accessory-to-phone mounting is preferably designed to withstand repeated attachment and detachment without degradation of the snap-on mounting or connector. Although the phone body is also durable, it is preferable to attach and detach the accessory by shifting the snap-on locks upward manually during the attachment procedure (like during detachment) to reduce wear of phone body near the latch.

The PCP (printed circuit board), located inside the accessory unit, is a multi-layer board, which may have 0.2 mm gaps, two solder mask layers, and silkscreen layer. The board preferably carries all the components, as illustrated in the schematics, excluding connectors and the speaker. Two outer layers of the board are signal layers; two internal layers are ground and 3.3V power plane. For convenience of the PCB assembly on modem plants, most packages are surface-mounted by not BGA. The board preferably does not contain any components requiring rare or custom-made equipment for their assembly.

The phone connector is preferably selected to maximize the firmness of the attachment, taking into account significant dimensions of the accessory unit. It should be mentioned that the connectors are unique to the type of phone used (Ericssom R520 and compatible, like R320 and T28, in this example).

Factors in the selection of the speaker for the music playback included sound quality, which is primarily related to the speaker size, compactness, and the weight of the speaker, as it is desirable that the speaker not be thicker and heavier than the phone itself depending on the available technology, there may be some tradeoff between good speaker quality and having a lightweight speaker. Speakers used in professional radio receivers-scanners may be a reasonable compromise since such speakers provide better than usual sound quality while possessing reasonable dimensions and weight. Other options include either sacrificing weight and dimensions to increase sound quality or using the new so-called “ceramic” speakers that are now appearing on the market. Mention should be made that although using these speakers could provide better quality, special modifications to the device would be required since these speakers could not be directly substituted in place of the standard ones.

It should also be noted that the bandwidth of the acoustic channel of the cellular phone which, in turn, is non-linearly compressed and transmitted over a digital channel of the phone, is much less than the bandwidth of the conventional landline phone and can deliver about 150 bytes per seconds data transfer rate. Conventional landline phone could deliver about 3700 bytes per seconds (V.34). Using better speakers on the phone would entail loading sound fragments of better quality (and, therefore, of bigger size), which would increase the time necessary to download a melody. The problem could be solved by using the GSM digital data channel directly which would provide a rate of about 1000 bytes per second for existing cellular networks and more than 7000 bytes per second for newly deployed systems. Alternative solutions include: having to tolerate an increase in the sound file or sound clip download time, downloading a melody from a local computer (the melody being delivered to the local computer by some alternate means), and redesigning the system to support conventional (landline) phones. In the latter case, due to significant increase in body size, it may make more sense to use a stereo-effect (which is reasonable when the speakers of left and right channels have enough spatial separation.)

### Server Software Description

The server described herein performs the following functions: 1) startup, detection of the modem, detection of the melodies available; 2) answering incoming calls; and 3) servicing requests of user via DTMF codes.

Upon startup, the application requests the user to select which device to work with. Possible options include local test mode (0), modem on COM1 port (1), and modem on COM2 port (2).

If the local test mode is selected, all sounds will be played back using the sound card of the local computer and the computer keyboard will be used to control the server (via numeric buttons instead of DTMF keyboard). This mode is primarily for system testing purposes.

If one of the modems is selected, all sounds will be played back into the phone line using the selected modem, and the calling party's phone keyboard (DTMF tones) will be used to control the server. This is the normal mode of server operation.

The answering if incoming calls is performed differently in the local and normal modes. In the local mode, the application waits for the ‘R’ key to be pressed to simulate remote party RING, while in the normal mode, the application waits for the RING signal from the modem. Then, in either mode, the application initializes the device used (sound card or modem). In the latter case, the modem goes “off-hook” and plays back the greeting message and the main menu 15 (e.g., 0-End of the session, 1-Current, 3-Next, 4-Load).

Thereafter, the application goes into calling party servicing loop. Exit from the loop is possible upon reception of DTMF code ‘0’ (or its simulation using the keyboard) or after the 30-seconds timeout if no reaction is detected from the remote user. Additionally, if working with the modem, the loop is exited when short beeps (“BUSY”) condition id detected on the phone line. In the local mode, the ‘X’ key also leads to the immediate exit of the application.

The calling party servicing algorithm may work as follows: the software keeps the internal counter or number of the current sound clip. Initially, this number “0” indicating that the clip is at the top of the list. Upon receiving the “1” command, the software plays back the clip with the current number. Upon receiving the “2” command, the software increases the number and plays back the melody, i.e., plays the next melody. Upon receiving the “3” command, the software decreases the number and plays back the melody, i.e., plays the previous melody. Upon receiving the “4” command, the melody download is simulated. For the obvious reason, this mode is not implemented yet. Upon receiving “0” command, the application switches the modem “on-hook” releasing the phone line and returns to the incoming call waiting state. Upon encountering any other command, the application plays back a standard error message. Upon encountering any other command, the application plays back a standard error message. At any moment, the server application can be aborted by pressing <Ctrl>C combination on the keyboard.

The server application keeps a log file (e.g., named “ProgramName_N.Log”) where N is a port number. Therefore, if two instances of the application are started, one for the modem on COM1 and the other for the modem on COM2, two independent log files will be created. The log file contains brief information about the user and server actions, times of events, their main features, for example, state of the modem or of the sound card. These files are intended to be sent to the software developers in case of problems but can be used for other purposes as well, for example, to estimate the server load.

Due to the fact that the server application always plays a melody with the same quality as one would be able to hear through the conventional phone channel [monophonic, 8 kHz-sampling rate (signal bandwidth up to 3.7 kHz)], the sound quality of the played back clips may be low. This is not related in any way with the quality of sound that would be digitally transferred to the client's phone when the melody is selected since listening to the clips from the server through the phone network could not deliver better quality than the phone channel itself For this reason, sound files compressed in monophonic versus stereo form would be preferred since the rate of delivery would be faster, with no loss in playback quality from the phone. At the same time, when the clips are downloaded in the phone in digital form, significantly better quality could be delivered upon playback due to the perceptual compression; however, this would increase the transfer time.

The server software could also be implemented to track which clips were sent to which user or subscriber. This information could then be tracked and reported to different third parties such as the Copyright Office, or performing or artist's rights organizations or societies.

### Devices for Accessing Sound and Image Files

Electronic devices adapted to receive sound and image data, according to the present invention, may be provided with an attachment or built in mechanism for providing consumers with Internet based or Internet free access to a library of downloadable sound and/or image files. Consumers may be allowed to download free clips of a song, musical composition, or other sound recording or movie or other performance onto any of these devices for use as alerts.

After hearing or viewing a clip, the user, preferably by the push of a button, may transact a purchase of the full file associated with the clip, which may be downloaded to the device in its entirety, or delivered to the user's address on an independent medium such as records, cassette tapes, CD's, videotapes, and DVDs. Such practice is intended to encourage the sales of sound and image files by giving the user the opportunity to quickly make an impulse purchase.

A device for downloading and listening to music files, which is similar to a walkman type I-pod™ device, but uses the same delivery method as described for the cellular phone comprises a speaker and/or an earphone set for listening to music with volume controls (such as Bose or Shure E5 universal earphones), and a server access element (which may be approximately the size of a credit card). Such a device may be used as a hand held portable music player, as well as a car radio or home system, and may include larger speakers for use as an audio system by businesses such as bars, restaurants, and clubs.

In addition to features, which allow a user to access the server library, the device may include other features common to conventional MP3 players and/or Apple I-pod™ devices. The server access element includes controls, which may be buttons, for accessing, browsing, and downloading files from the server to the device. Speed dial technology may be used for accessing the server.

For browsing, a multi-task arrows button, which allows the user to browse, listen to samples, and highlight specific selections, may be provided.

The server access element may include a small LCD monitor (approximately 1″×1.75″) for text browsing the server library. A small microphone hole may also be included for allowing the user to browse the library using voice commands. The earphone set or speaker will enable the user to listen to downloaded music files.

Downloaded files may be stored on a device storage list for accessing at all times, or deleted. Thus, the user may access a library containing a large number of sound files, and browse, download, and listen to music, without the Internet or the need to plug into a computer. The consumer may be charged a fee for each download, or may be able to purchase actual items, for delivery to an address indicated by the user, such as records, cassette tapes and CD's through the access element. Free clips, which the user can download, may induce the consumer into purchasing the entire sound file from where the clip originated.

The device may also include a mechanism for allowing a user to store downloaded files on a medium, such as a card, independent of the device. To this end, the device may provide a slot into which a storage card may be inserted, such that when the device is full, files may be downloaded onto the card for emptying space on the device. A security mechanism may also be included to prevent intellectual property abuse, for example, by preventing users from playing copied files on other devices as described above. Such devices may further include a monitoring feature, which would allow performing rights organizations such as ASCAP and BMI to keep track of music publicly played by businesses such as bars, restaurants, and clubs for the purpose of paying out royalties.

A schematic diagram for a media file monitoring system 1800, according to a preferred embodiment, is shown in FIG. 18, for use with an I-pod™ type listening device 1802, wherein a consumer may purchase copyright registered media files which are downloaded wirelessly to the device 1802. The system 1800 includes an existing Wireless network 1804 of 1.5G or more, a system-monitoring server 1806, and a system content server 1808. The monitoring server 1806 monitors and counts every file delivered to the consumer device 1802, for monitoring and counting every file delivered to the device 1802. The server 1806 may track each individually titled file, which may include information such as song title and artist name, purchase price, the consumer's name, and other identity information, time of delivery, and any other pertinent information. The server 1806 may also protect encrypted copyrighted files from illegal file copying. The content server 1808 stores copyrighted digital media content licensed from multiple entertainment companies. Thereafter, monitoring information, including statistics may be transmitted (e.g., through the Internet) to a company or organization. The system described may also apply to a viewer device for monitoring image files.

A portable laptop type viewer device, for accessing and viewing image and/or sound files, may comprise a wireless earphone set and/or speaker for listening to programs with volume controls, and a Personal Digital Assistant (PDA) with a monitor which may be approximately the size of a laptop computer. This device allows the user to access a server library containing a large number of movies, TV shows, cartoons, and other files, using either text or voice activation, without the need to plug into a computer or use of the Internet or other computer based wireless telecommunication system.

The files may be categorized and subcategorized by type of file (i.e., movies, TV shows) then by title of name of main actors. TV shows may further be classified by providing a description for each episode, similar to a description provided in a TV guide™. Other categories and subcategories of classification may be provided to allow the user to identify the exact category he wishes to access.

The device allows the user to browse, download, preview, store and view his selections, (using text, voice, or button commands), wherein a fee may be charged by the provider for any or all of these options. The files may be made available as clips as well as in their entirety. The viewer device may include a folder containing previously downloaded image files that can be accessed at any time and deleted and desired. The library may be organized by categories such as type of show (i.e., movies, TV sitcoms), names of actors, show titles, sitcom description (e.g., as appearing in TV Guide™) etc.

Method of Advertising using Delivery of Sound Clips

The method of delivering sound and image files, in accordance with the present invention, can further be utilized as an advertising tool. To this end, any of the above-described systems carrying the library of sound and/or image files, which include a website and non-Internet accessible holding unit, may be used to expose the user to sponsored advertising messages. For example, a user calling the holding unit may hear advertising while the system is accessing the library.

Utilizing a phone or other electronic device using alerts according to the present invention may provide other advertising opportunities. For example, the phone may ring with advertising gimmicks such as promotional messages. Such advertisement gimmicks may be played as default rings when no clip is selected for the ring. Additionally, a phone may be programmed to play, or transmit advertisements spontaneously. Clips containing advertising messages such as jingles may also be provided. Advertising messages may be tacked onto a user-selected clip of a popular song or the like.

### Method of Distributing Music and Audiovisual Works to Consumers

A method of distributing music and audiovisual works to consumers while accounting to copyright owners of the works comprises: (a) Making available on a website various selections of works in various categories for review by identifying information and offering a portion of the work for hearing or listening, each work being coded internally with identification to a copyright owner or its representative; (b) Allowing consumers to select the viewable or listen able portion for data storage online or for downloading to the consumers' electronic devices at home wherein the downloaded file being encrypted to only play on the consumer's electronic devices first receiving the download; (c) Optionally tracking those consumers who received the download of the portion of the work and reporting to the copyright owners of their representatives information concerning the download; (d) Allowing a consumer to return to the website to purchase and download a complete copy of the copyrighted work previously sampled by the consumer; (e) Conducting an online purchasing transaction and charging the consumer for the download; (f) Downloading a complete copy of the copy-righted work to the consumer in an encrypted fashion so as to be playable only in the consumer's electronic device and not exchangeable with third parties; (g) Tracking those consumers who received the download of the copyrighted work and reporting to the copyright owner of their representatives information concerning the download; and (h) Paying the copyright owners or their representatives a portion of the money received from the consumers for their downloading of the copyrighted work.

### Method of Playing User Selected Sound Files on Radio

A device containing sound files, in accordance with the present invention, may further include broadcasting capabilities, for broadcasting sound files to a local radio at a set frequency. In accordance with a preferred embodiment, such device will be a small box which may contain a large number of user sound files, and will be capable of broadcasting only over a short distance, say approximately 1-15 feet. Thus, a user will be able to keep the box in his car, or near a home system, which includes a radio, and broadcast selected files to a specific radio station at which the box is set to broadcast. This will enable the user to play sound files, which were selected and stored on the box, on a regular radio, without the use of CD's or tapes. Since a large number of CD's are capable of being stored on the box, according to the method of the present invention, the number of songs which a user of the box would have access to in his car would far exceed the number of songs available on CD's which the user can practically carry in his car. Additionally, the system, through broadcasting and radio, will avoid and FCC legal violations since the broadcasting may only be done at a very short range, and hence, only to a radio or radios which are very close to the box. This box may be of various sizes, as desired.

Additionally, the sound quality can be made almost indistinguishable from CD quality using the parametric optimization algorithm, wherein the sound file may be optimized to work with the speaker system. As such, the sound quality will depend on the speaker quality. This system may use digital radio, start with FM and convert to digital, or other methods, as desired.

### Client Software Application for Advanced Cellular Phones

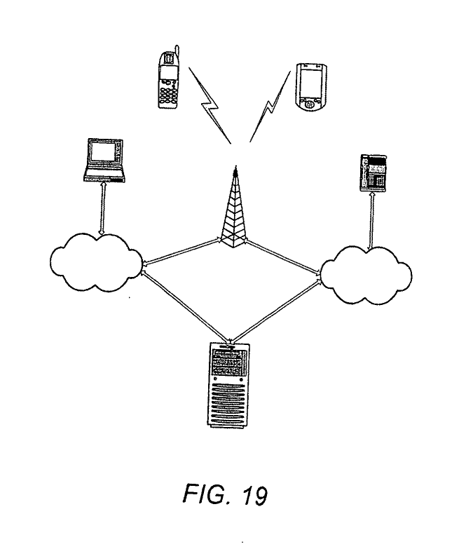

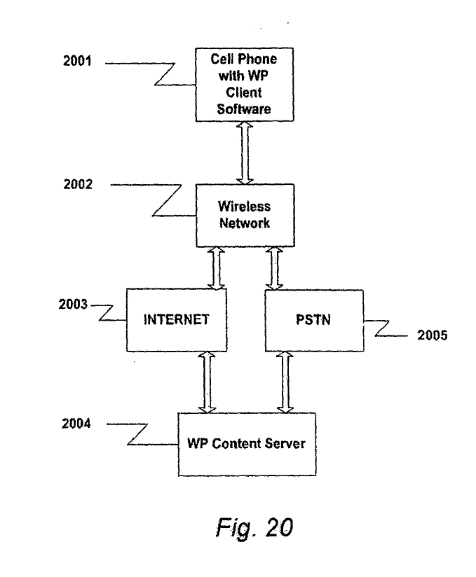

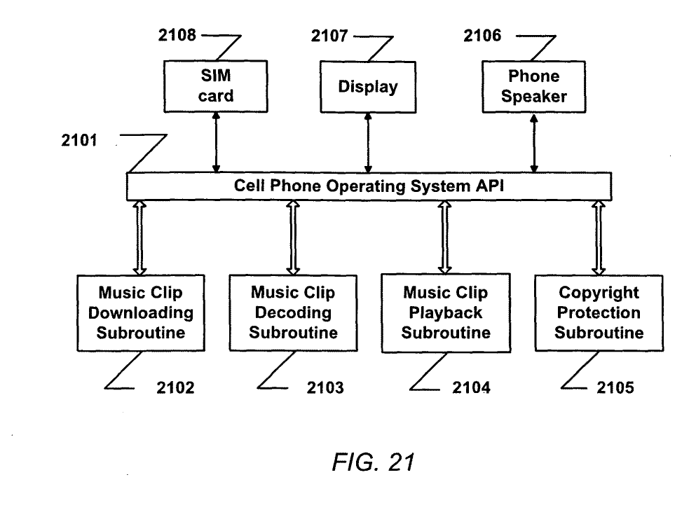

A software-only based client application for encoding into advanced cellular phones with delivery, storage, and playback capabilities in accordance with the present invention is described below. Such advanced cell phones are, for example, Symbian OS cell phones like Nokia 7650, Nokia 3650, SonyEricsson P800 smartphone, etc. FIG. 19 is a conceptual diagram of the overall system 1900, including a cell phone 2000 and other devices, which may access a content server 2004. FIG. 20 is a schematic diagram illustrating the basic components of an advanced cell phone system having delivery, storage, and playback capabilities. The system is comprised of an advanced cellular phone 200 running client software 201, a system content Server 2004 with server software and data transportation networks 2002, 2003, 2005.

The phone user may access the content server 2004, which includes sound clips, by operating the client software application 2001 installed on cellular phone 2000. The server 2004 may display a list of music clips on the display screen of the cellular phone. The user can request the server 2004 to download a selected music clip. This request may be issued from the client software 2001. A cellular phone 2000 is specified by subscriber identity information from a cell phone smart card such as SIM (Subscriber Identity Module) Card, which may be inserted into GSM cell phones and contains telephone account information. This enables the server 2004 to recognize the particular cellular phone 2000 and download the music file to that phone.

The client software 2001 is hardware independent, client software-only solution and requires no particular hardware in the host cell phone 2001. It uses a general model of the advanced cell phone's audio output hardware and a set of host interface functions to adapt each implementation to the particular cell phone audio output system. Since smart phones (also known as advanced phones, 2.5 Generation phones) integrate a fully featured personal digital assistant (PDA) and traditional mobile phone in one unit, an operating system of such phones is open for third-party development additional applications and services (in contrast to operating systems of previous phone generation, adopted by mobile phone manufacturers several years ago). For example Symbian OS supports standard languages such as C++ and Java, along with SDKs, tools, documentation, a rich set of APIs and technical support for independent software developers.

The software 2001 uses a multimode telephony interface or API (Application Program Interface). This API abstract cellular network preferably includes GSNI (Global System for Mobile Communications), EDGE (Enhanced Data rates for Global Evolution), CDMA (Code Division Multiple Access), W-CDMA (Wideband-CDMA), and UNITS (Universal Mobile Telecommunications System), and it makes it easier to move the software 2001 from one mobile phone standard to another.

The cell phone API encapsulates communication between the software 2001 and cell phone hardware. This enables branded audio content such as recorded music and spoken work recordings. It also can be used to trigger playback of digital audio recordings in response to program conditions, for example, audio caller ID functions, a device audio logo that played upon power up, or recorded pop music clips that play when buttons are pressed, etc. As such, the cell phone API provides a possibility to switch and synchronize dynamically different functions of cell phone such as caller ID function, digital audio playback function, digital audio recording function, etc.

Because advanced cell phones contain both DSP and microprocessor hardware, the software 2001 may be optionally split into two parts: a microprocessor module containing the master functions and a DSP module containing all music and audio rendering functions. Communication between the two modules is achieved by means of API communications.

A schematic diagram illustrating the system 2100 for the client software 2001, in accordance with a preferred embodiment, is shown in FIG. 2.1. The system 2100 includes a cell phone operating system API 2101, a music clip downloading subroutine 2101, a music clip decoding subroutine 2103, a music clip playback subroutine 2104, a display unit 2107, and a phone speaker 2106. The system may further include a copyright protection subroutine 2105, and a SIM card interface 2108. The cell phone OS (operating system) 2101 should meet common requirements for advanced 2.5G and 3G mobile smart phones AS that includes a multi-tasking kernel, integrated telephony support and communications protocols. (Symbian OS or Windows' CE are examples of such systems).

The software 2001 uses the following system API of cellphone OS:
Multimedia API-This provides for sound playing and manipulation, Manipulation, and format conversion.
Graphics API-This provides for drawing capabilities including drawing of lines, shapes, text, and bitmaps. This also provides access to The Window's 15 server and animation APIs.
Telephony API—This provides a generic interface to initiate, control, and

Terminate telephone calls. Also, a client can get status and Capabilities information, and can be notified of changes.
Networking API—This provides multimode cellular telephony network Interface, making it easier to move the software application 2001 From one mobile phone standard to another. This also provides TCP/IP (Transmission Control Protocol Internet Protocol) Communication services in conjunction with the Sockets Client API;

The music clip downloading subroutine 2102 provides for browsing of the content server 2004, and selecting and downloading of music clip files utilizing XHTMLIHTML browser capabilities. The subroutine 2102 utilizes Networking API for interaction with content Server software via a TCP/IP protocol or Telephony API for interaction by means of the PSTN. A graphical user interface is implemented by using Graphics API. Subroutine 2101 also interacts with the copyright protection subroutine 2105.

The music clip decoding Subroutine 2103 utilizes Multimedia API to provide sound clip decoding in correspondence with the above-mentioned procedure for Audio Data Parametric Optimization and Compression (method 1500). The subroutine 2103 is preferably activated via a request from the copyright protection subroutine 2105, wherein the subroutine 2103 decodes the audio file and activates subroutine 2104 for playback of the audio file.

The music clip playback subroutine 2104 provides for the interception of an incoming call signal using the Telephony API, and playback of a correspondent music clip via a phone speaker system 2106 in accordance with a caller ID setup, and utilizes the Multimedia API and graphical user interface by using Graphics API and the display 2107. Subroutine 2104 also interacts with the music clip decoding subroutine 2102 and the music clip downloading subroutine 2102.

The copyright protection subroutine 2105 prevents the unauthorized playback and reproduction of digital music, and prevents the sharing of protected music between cellular phones and other mobile devices. Subroutine 2105 uses subscriber identity information of the telephony SIM card 2108 as an authorization key that would enable the user to be authorized. The copyright protection subroutine 2105 transmits the user's authorization key to the content server 2004 when the user requests the server to download a selected music clip file. After the clip file has been downloaded from the server to the telephone, subroutine 2105 receives the file from subroutine 2102, provides decryption of the file, extracts the file authorization key and compares the key with the actual subscriber identity information. If the comparison matches, subroutine 2105 transfers the file to the music clip decoding subroutine 2103.

The content server 2004 is a computer running server software that is designed to execute requests of the client software 2001 of the cell phone 2000, which may be given through TCP/IP protocol or using DTMF signals of the phone keys as described above and shown in FIGS. 2 and 12.

The system 2100 enables a connection to the server 2004 upon a request from the client software 2001 of the cell phone 2000. The server 2004 provides for content browsing, selecting and downloading of music clip files to the cell phone 2000 through the Internet 2003 or through the PSTN 2005 (FIG: 20). The server further allows for files to be transmitted to the cell phone 2001 utilizing client software authorization and support. The server may store or be capable of accessing a music clip database.

The Server 2004 utilizes a sound file optimization and compression algorithm, shown in FIG. 15, which converts common music files into compressed files that are downloaded and stored under a user's request by the client software 2001 to the cell phone 2000.

Also the server software provides copyright protection functions. When the user requests the server 2004 to download a music clip file, the server software requests user's authorization key from the client software 2001, inserts the authorization key into the music clip, encrypts the file and then uploads the encrypted file to the cell phone 2001.

The delivery system, according to the present invention will further integrate with future wireless technology, such, as it becomes available, for offering enhanced capabilities for accessing, delivering, and using sound and image files.

While the present invention has been described with reference to exemplary embodiments, it will be understood that various changes and additional variations may be made and equivalents may be substituted for elements thereof without departing from the scope of the concepts disclosed herein. In addition, many modifications may be made to adapt to particular situation or material to the teachings of this disclosure without departing from the essential scope thereof Therefore, it is intended that the disclosure not be limited to particular embodiments disclosed herein for carrying it out, but that the disclosure includes all embodiments failing within the scope of the appended claims.

What is claimed is:

1. A method for delivering a multimedia data file comprising advertising content and/or advertising visuals and/or copy from a one or more servers to an an electronic device or devices, comprising:
compressing said multimedia data file using a compression algorithm;
and transmitting the compressed file with or without an Internet connection either wirelessly or by wireline to an electronic device effective for receiving and playing back said multimedia data file.

2. The method of claim 1, further comprising storing the file on the electronic device or in a remote storage medium.

3. The method of claim 1, further comprising playing the file on the electronic device.

4. The method of claim 1, further comprising computer-implemented method for operating the device, the method comprising:
presenting an advertisement in the device; and
enabling a function in response to the advertisement ending or at some point during the advertisement.

5. The computer-implemented method of claim 4, wherein the operating system is scheduled to perform the disabling, presentation and enabling steps at predefined times.

6. The computer-implemented method of claim 4, further comprising selecting the function among a plurality of functions before each advertisement presentation.

7. The computer-implemented method of claim 8, further comprising determining, before each advertisement presentation, at least one activity being performed in the device, wherein the function is selected using the determination.

8. The computer-implemented method of claim 4, further comprising:
receiving user input prompting the presentation of the advertisement to be postponed for a predefined amount of time;
postponing, in response to user input, the presentation of the advertisement by the predefined amount of time; and reducing a time until a subsequent advertisement is presented by the predefined amount of time.

9. The computer-implemented method of claim 4, further comprising:
receiving user input prompting the advertisement to be presented a predefined amount of time earlier than scheduled, wherein the advertisement is presented according to the use input; and
extending, in response to the user input and by the predefined amount of time, a time until a subsequent advertisement is presented.

10. The computer-implemented method of claim 4, wherein the advertisement is presented using a presentation technique selected from the group consisting of:
presenting the advertisement as a pane on top of any other pane in a user interface of the device;
presenting the advertisement in a designated area of a background of the user interface;
presenting the advertisement in a window for an application program;
presenting the advertisement inserted in content from an application program;
presenting the advertisement through an audio output of the device; and
combinations thereof.

11. The computer-implemented method of claim 4, further comprising:
determining whether a user pays attention to the advertisement.

12. The computer-implemented method of claim 13, wherein the determination comprises:
performing, while the advertisement is presented, an operation that urges the user to respond; and
detecting whether the user responds to the performed operation.

13. The computer-implemented method of claim 4, further comprising presenting in the device a user-selectable control that when activated triggers at least one selected from the group consisting of:
causing presentation of a page from an advertiser associated with the advertisement;
recording a user raring of the advertisement;
again presenting the advertisement;
sharing the advertisement with another user;
initiating a transaction for user purchase of a product;
postponing presentation of the advertisement;
causing the advertisement to be presented ahead of schedule;
causing a previous advertisement to be presented;
causing a preview of subsequent advertisements to be presented;
causing an overview of all available advertisements to be presented; and
initiating a transaction for user purchase of a product or service to which the advertisement relates.

14. The method of claim 1 further comprising a computer program product tangibly embodied in a computer readable medium and comprising instructions that when executed by a processor perform a method for operating the device, the method comprising:
presenting an advertisement in the device; and
enabling the function in response to the advertisement ending.

15. The method of claim 1 further comprising a computer-implemented method for providing an advertisement in a device, the method comprising:
providing an operating system of a device with at least one advertisement, the operating system configured to present the advertisement in the device; and
receiving a report from the device confirming that the advertisement has been presented.

16. The computer-implemented method of claim 17, further comprising configuring the operating system to perform the presentation at predefined times.

17. The computer-implemented method of claim 17, wherein the report further identifies usage of the device relating to the presentation of the advertisement.

18. The computer-implemented method of claim 17, wherein the advertisement is selected to be provided to the device based on information about a user of the device.

19. The method of claim 1, further comprising a computer program product tangibly embodied in a computer readable medium and comprising instructions that when executed by a processor perform a method for providing an advertisement in a device, the method comprising:
providing an operating system of a device with at least one advertisement, the operating system configured to present the advertisement in the device; and
receiving a report from the device confirming that the advertisement has been presented.

20. The method of claim 1, further comprising an operating system tangibly embodied in a computer readable medium and comprising:
an advertisement that the operating system is configured to present to a user; and
a function that the operating system is configured to present the advertisement and the enable in response to the advertisement ending.

21. The operating system of claim 22, wherein the advertisement is presented using a presentation technique selected from the group consisting of:
presenting the advertisement as a pane on top of any other pan in a user interface of the device;
presenting the advertisement in a designated area of a background of the user interface;
presenting the advertisement in a window for an application program;
presenting the advertisement inserted in content from an application program;
presenting the advertisement through an audio output of the device; and
combinations thereof.

22. The method of claim 1, wherein the electronic device is a wireline telephone or cell phone,
and wherein the file is a sound and/or image file played to alert the user of an incoming call.

23. The method of claim 22, wherein a segment of the sound and/or image file is played to
alert the user to the call.

24. The method of claim 23, wherein said segment may be played repeatedly to alert the user to the call.

25. The method of claim 24, wherein the sound and/or image file is capable of being associated with a specific caller's telephone number, wherein the file plays when the specific caller calls.

26. The method of claim 25, wherein a plurality of sound and/or image files are delivered
and stored on said telephone, and wherein a user of said telephone may associate one specific file of said plurality of files with one specific caller from a plurality of callers.

27. The method of claim 26, wherein said telephone being shared by a plurality
of users, wherein a plurality of different sound files are delivered to, and
stored on, said telephone, and wherein a specific sound and/or image file of said
plurality of files is associated with a specific user of said plurality of users, wherein said specific file alerts the user of an incoming call where said specific user is the intended recipient of said incoming call.

28. The method of claim 1, wherein said transmitting is accomplished, at least in part, via a packet switched data system.
